(19) United States
(12) Patent Application Publication
(10) Pub. No.: US 2025/0244865 A1
(43) Pub. Date: Jul. 31, 2025

(54) USER INTERFACES FOR DISPLAYING A TRANSCRIPT OF A CONTENT ITEM

(71) Applicant: Apple Inc., Cupertino, CA (US)

(72) Inventors: Uli M. SCHOBERL, San Francisco, CA (US); Christopher M. MARTIN, San Francisco, CA (US); Christina CHATFIELD, San Francisco, CA (US)

(21) Appl. No.: 19/035,745

(22) Filed: Jan. 23, 2025

Related U.S. Application Data
(60) Provisional application No. 63/624,264, filed on Jan. 23, 2024.

(51) Int. Cl. G06F 3/0485; G06F 3/0482; G06F 3/04842; G06F 3/04883

(52) U.S. Cl. CPC G06F 3/0485; G06F 3/0482; G06F 3/04842; G06F 3/04883

(57) ABSTRACT

Some embodiments described in this disclosure are directed to an electronic device playing a content item and while playing the content, the electronic device displays a content user interface including a transcript of the content item. In some embodiments, the electronic device decelerates scrolling of the transcript of the content item.

### CROSS REFERENCE TO RELATED APPLICATIONS

This application claims the benefit of U.S. Provisional Application No. 63/624,264, filed Jan. 23, 2024, the entire disclosure of which is herein incorporated by reference for all purposes.

### FIELD OF THE DISCLOSURE

This disclosure relates generally to user interfaces presenting transcripts of content items.

### BACKGROUND OF THE DISCLOSURE

User interaction with electronic devices has increased significantly in recent years. These devices can be devices such as computers, tablet computers, televisions, multimedia devices, or mobile devices. In some circumstances, users want to efficiently view transcription information.

### SUMMARY OF THE DISCLOSURE

Providing efficient ways of presenting a transcript of a content item to a user improves the user's experience with the electronic device and reduces the number of inputs needed to view transcription information, thereby reducing power usage and improving the battery life of the electronic device.

Some embodiments described in this disclosure are directed to an electronic device configured to initiate display of a transcript in synchrony with a content item being played. In some embodiments, scrolling the transcript in accordance with a scrolling input includes decelerating the scrolling in response to a determination that a currently displayed portion of the transcript includes a portion of the transcript that corresponds to a current playback position of the content item.

By scrolling a transcript based on a deceleration profile that includes decelerating by an amount while displaying a portion of the transcript that corresponds to a current playback position of a content item, the electronic device provides a quick and efficient way of aligning display of the transcript to the current playback position without requiring the user to provide further inputs to precisely locate the portion of the transcript that corresponds to the current playback position, thereby reducing errors in interacting with user interfaces, which provides a more efficient user-electronic device interface, reduces power consumption, and improves battery life of the electronic device. The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIGS. 3A-3G are block diagrams of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6CC illustrate exemplary ways in which an electronic device decelerates scrolling a time-synchronized transcript of a content item in accordance with some embodiments.

FIG. 7 is a flow diagram illustrating a method in which an electronic device decelerates scrolling a time-synchronized transcript of a content item in accordance with some embodiments.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used and structural changes are optionally made without departing from the scope of the disclosed embodiments.

There is a need for an electronic device to dampen a scrolling motion to an amount less than an amount associated with the scrolling motion while displaying a transcript in response to a determination that a currently displayed portion of the transcript includes a portion of the transcript that corresponds to a current playback position of the content item. Such techniques can prevent scrolling past the portion of the transcript that corresponds to the current playback position of the content item and can reduce the need for subsequent inputs to precisely locate the portion of the transcript that corresponds to the current playback position, thus enhancing the user's interaction with the device. Further, such techniques can reduce processor and battery power otherwise wasted on user inputs to perform operations to locate the portion of the transcript that corresponds to the current playback position.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### Exemplary Devices

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component (e.g., a display device such as a head-mounted device (HMD), a display, a projector, a touch-sensitive display, or other device or component that presents visual content to a user, for example, on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

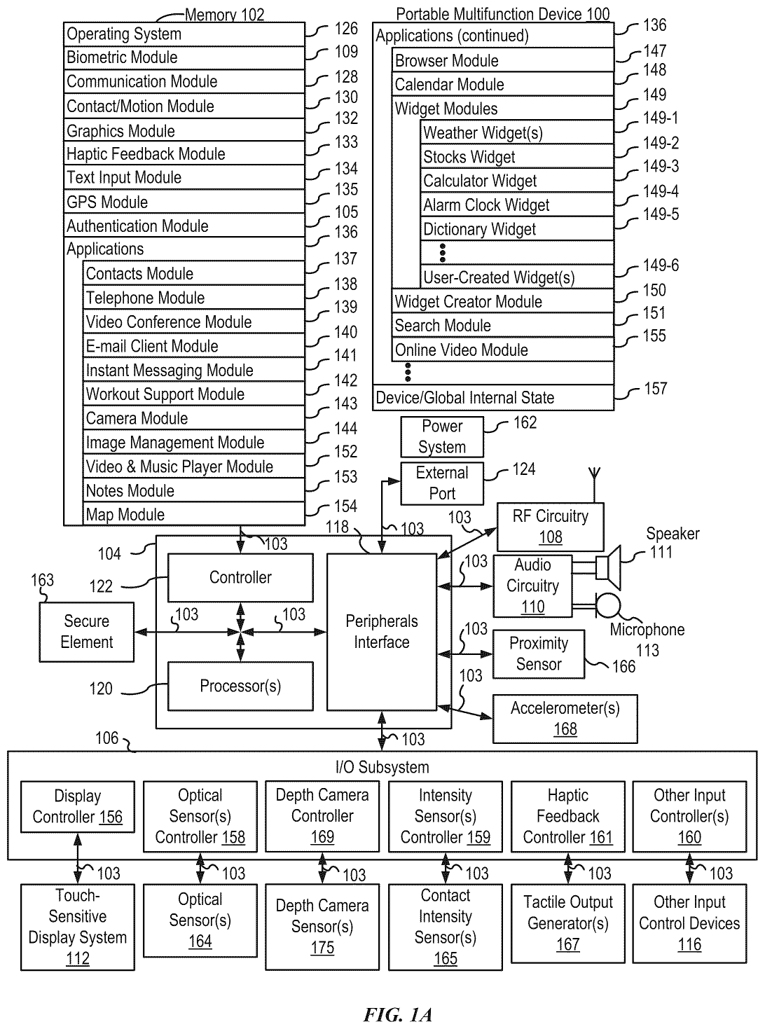

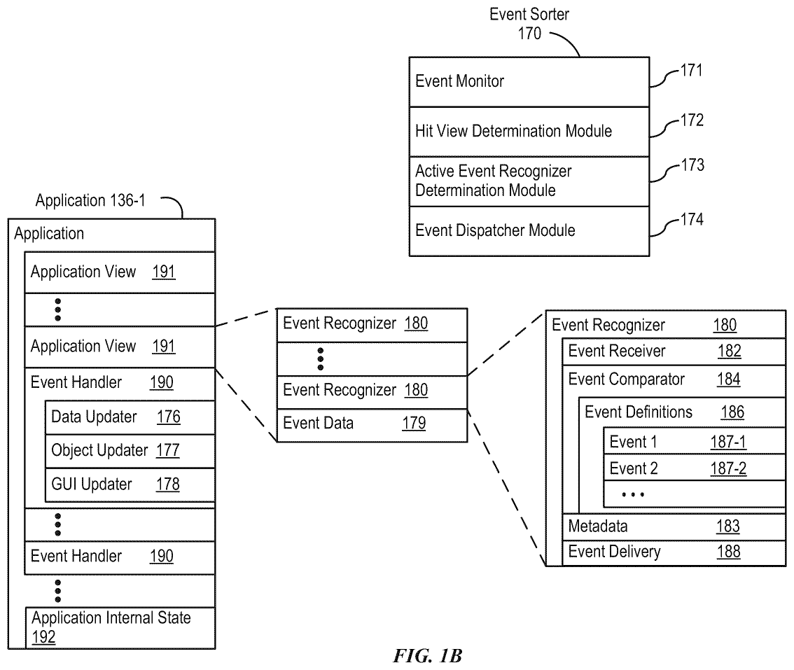

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as a “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

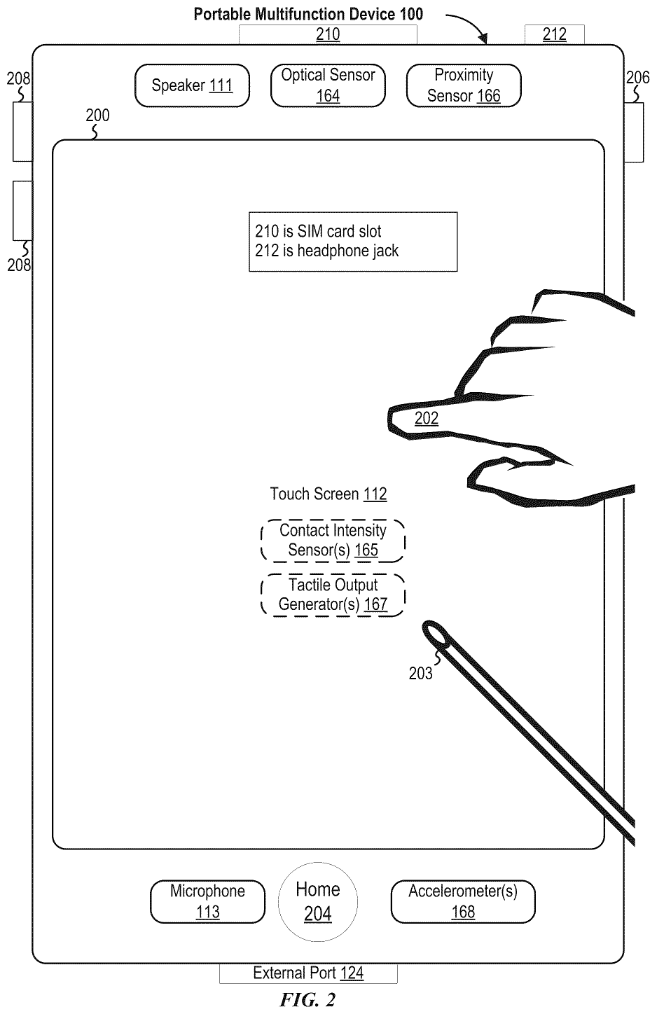

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's car (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

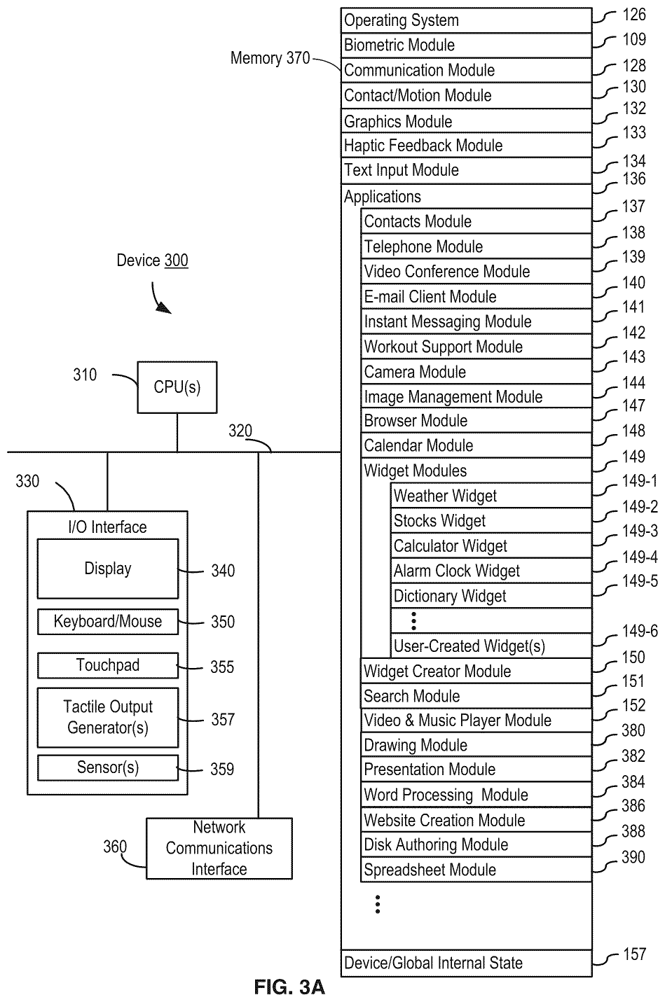

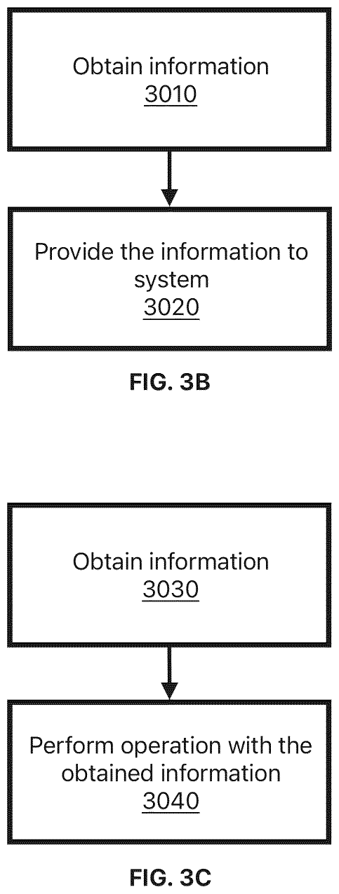

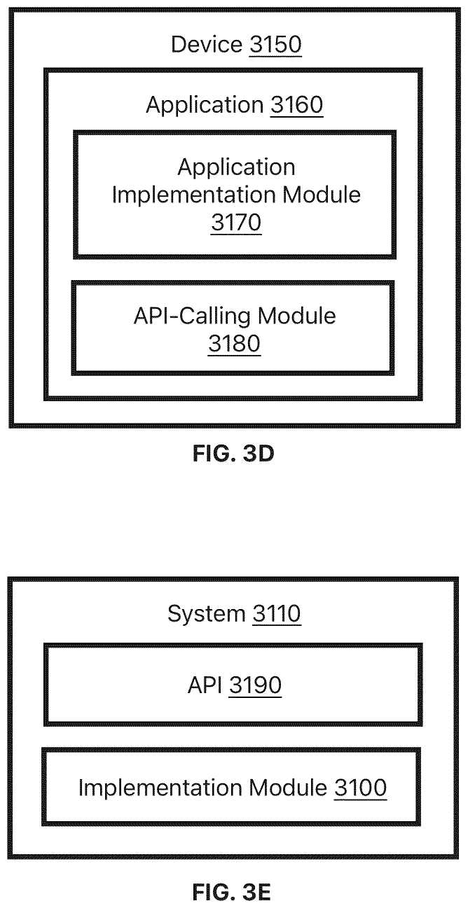

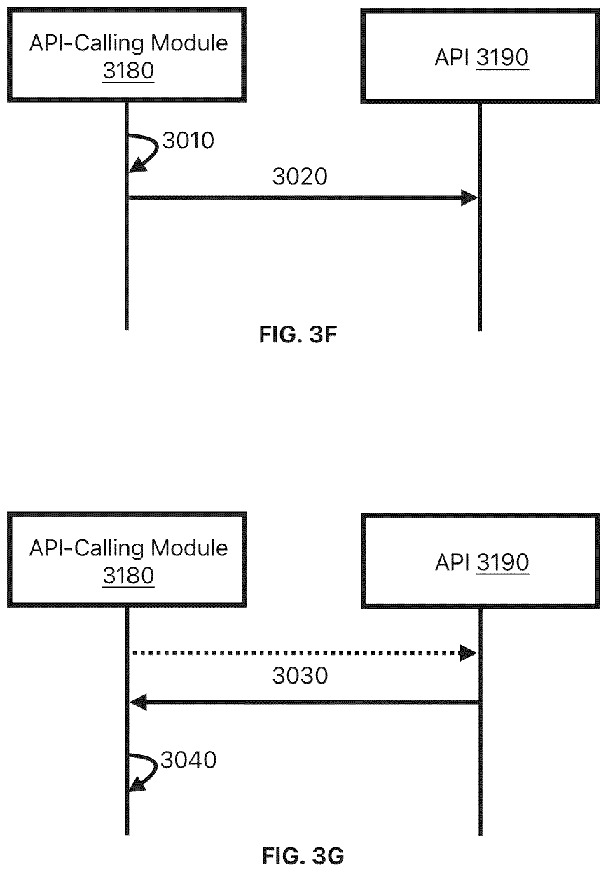

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), c-mail address(es), physical address(es) or other information with a name; associating an image with a name; categorizing and sorting names; providing telephone numbers or e-mail addresses to initiate and/or facilitate communications by telephone 138, video conference module 139, c-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192.

Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call docs), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

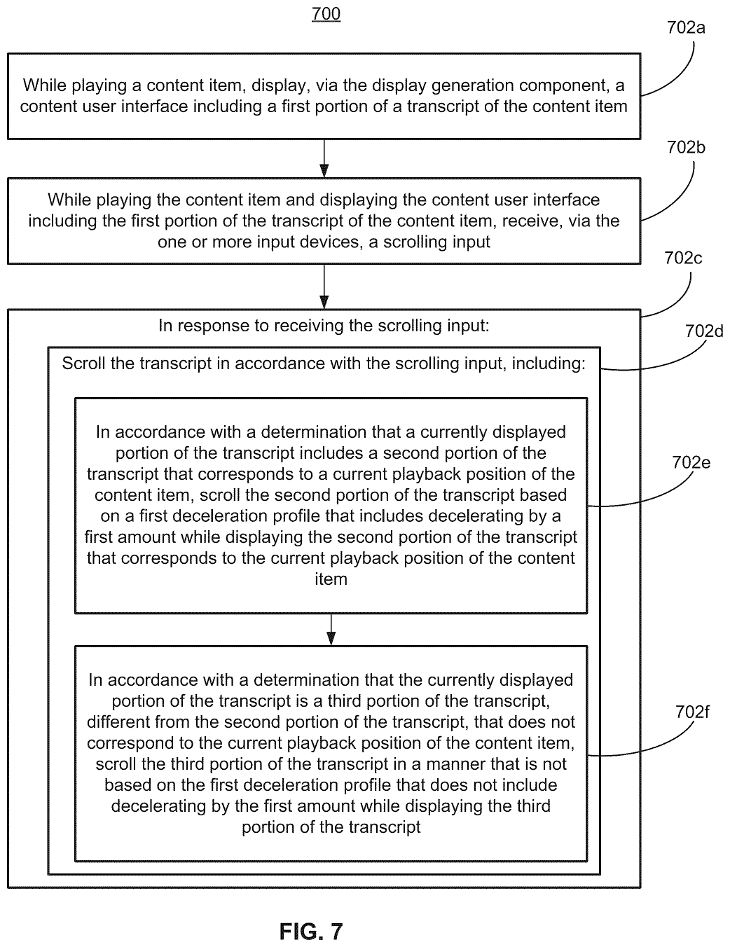

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

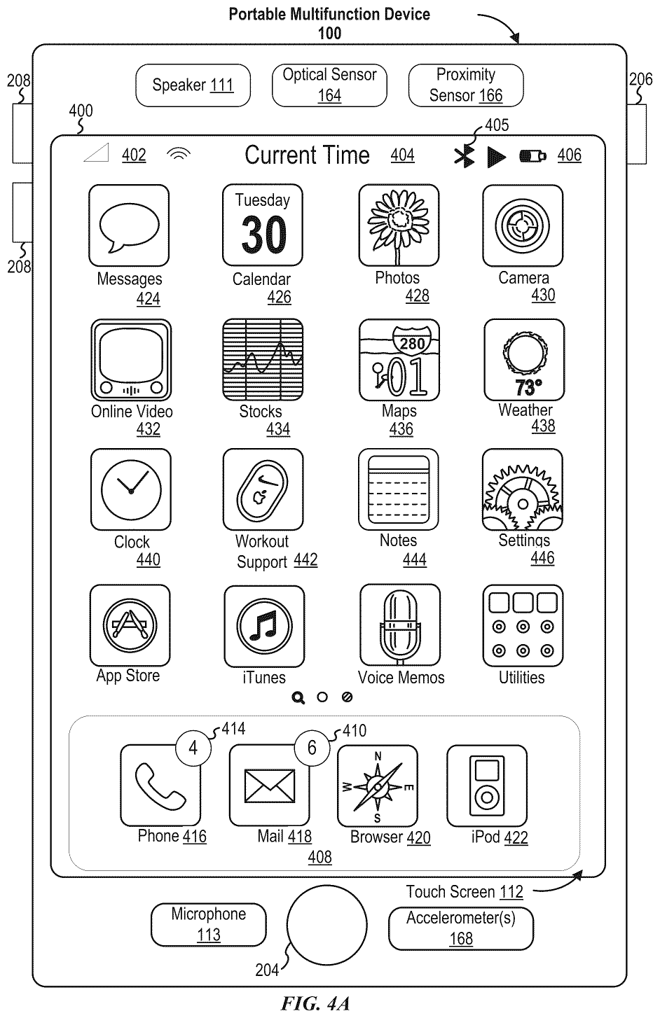

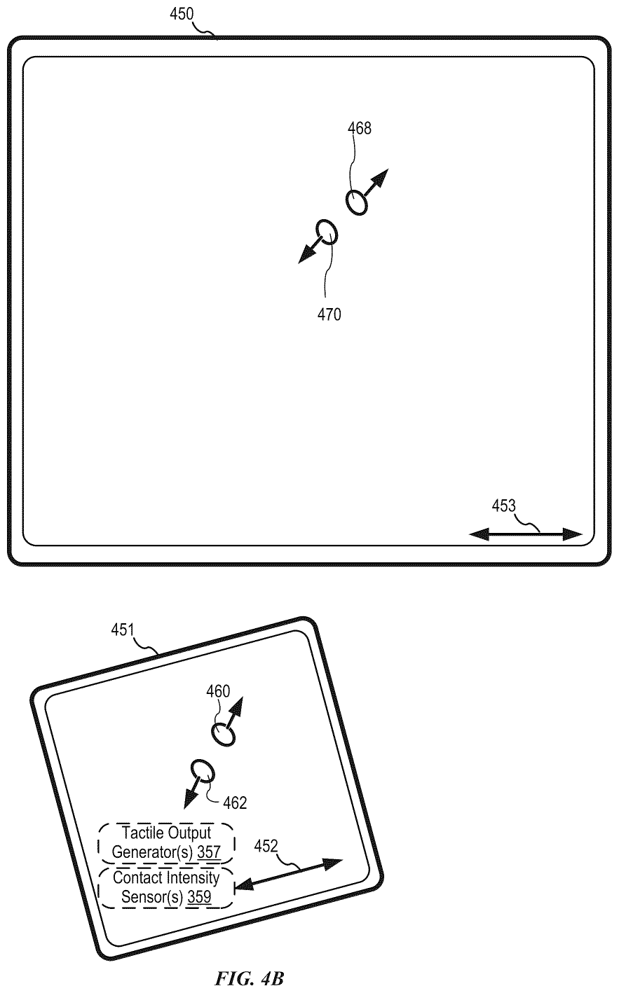

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

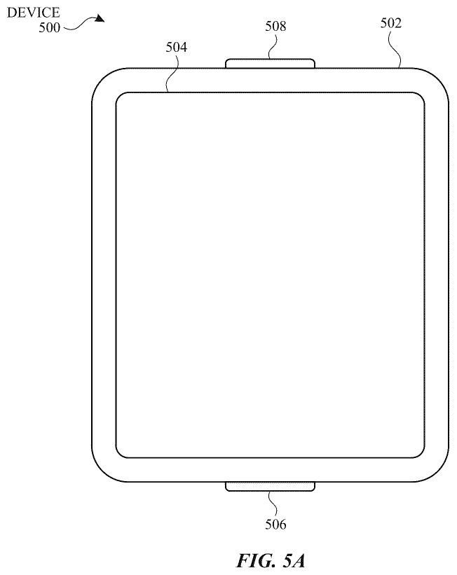

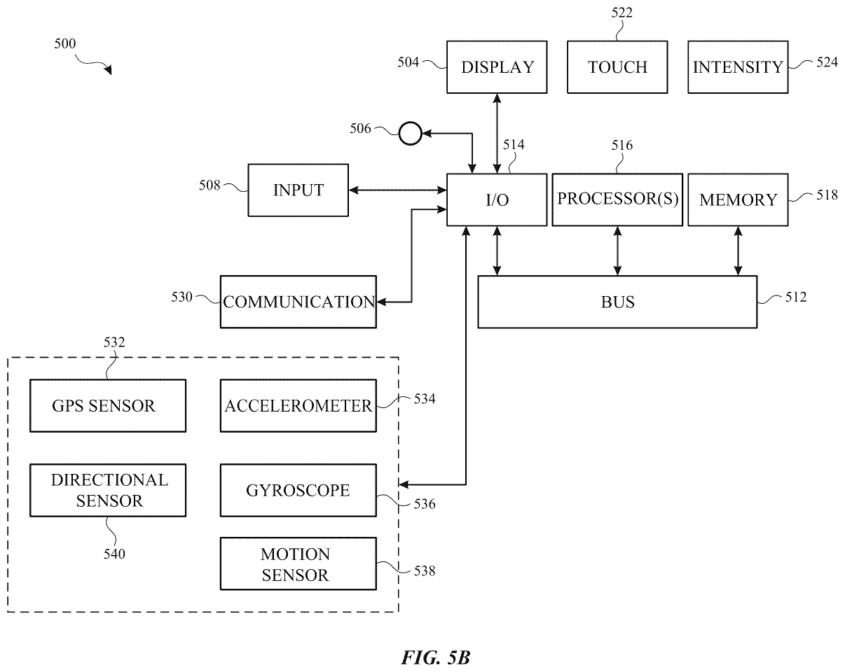

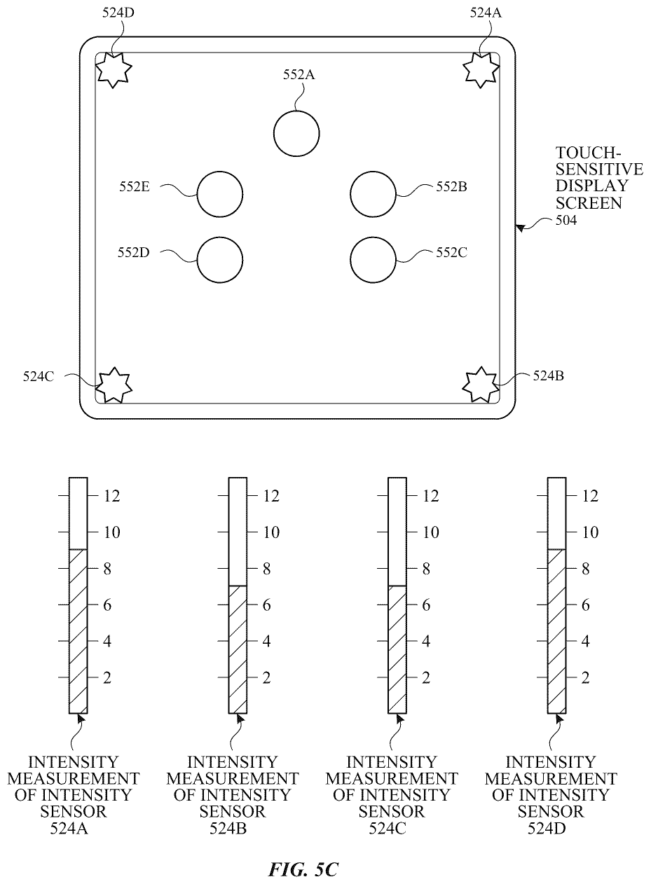

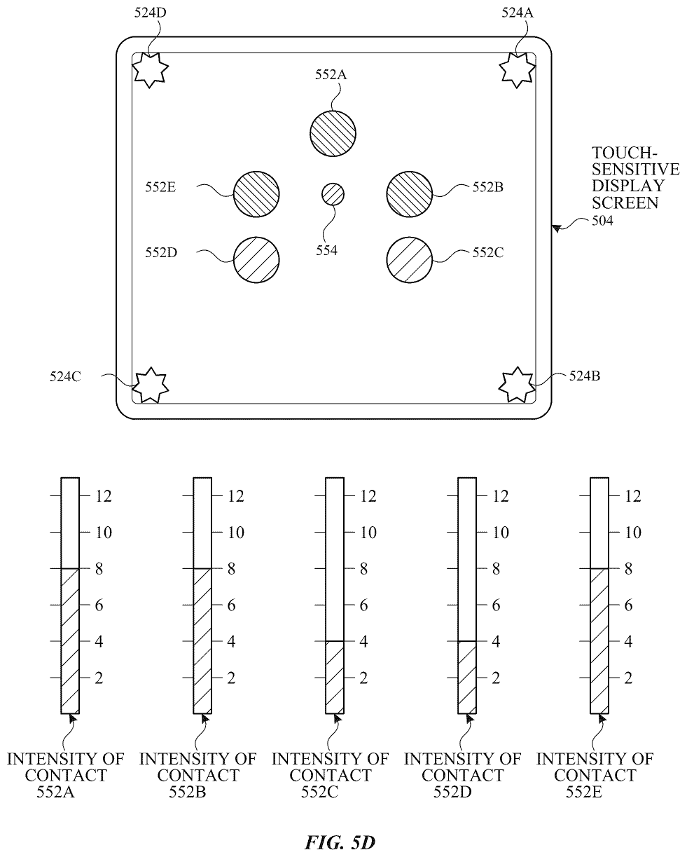

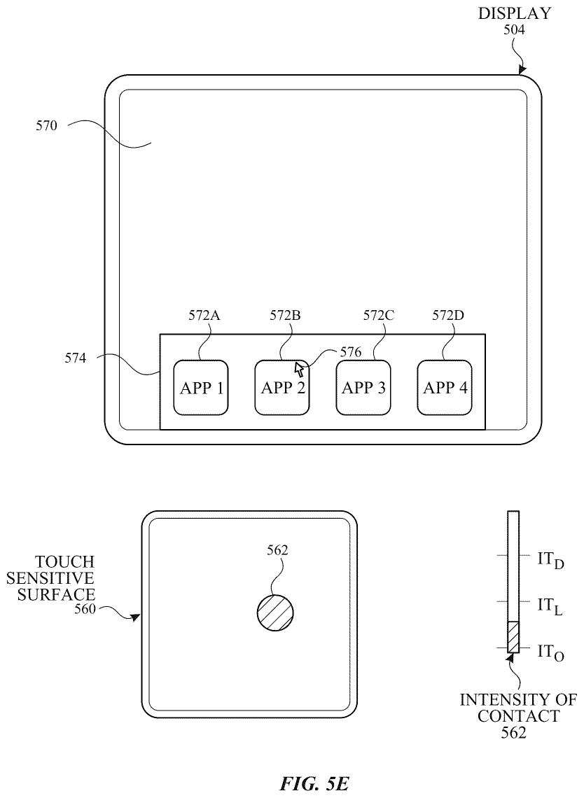

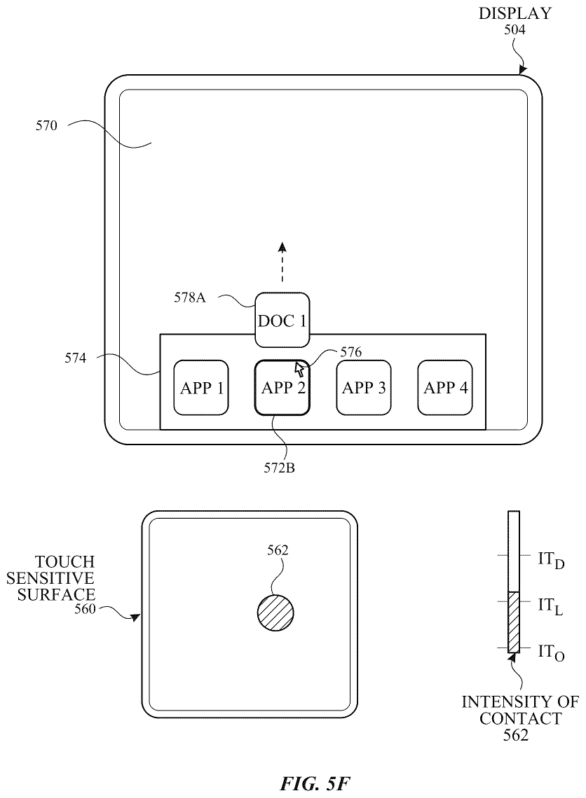

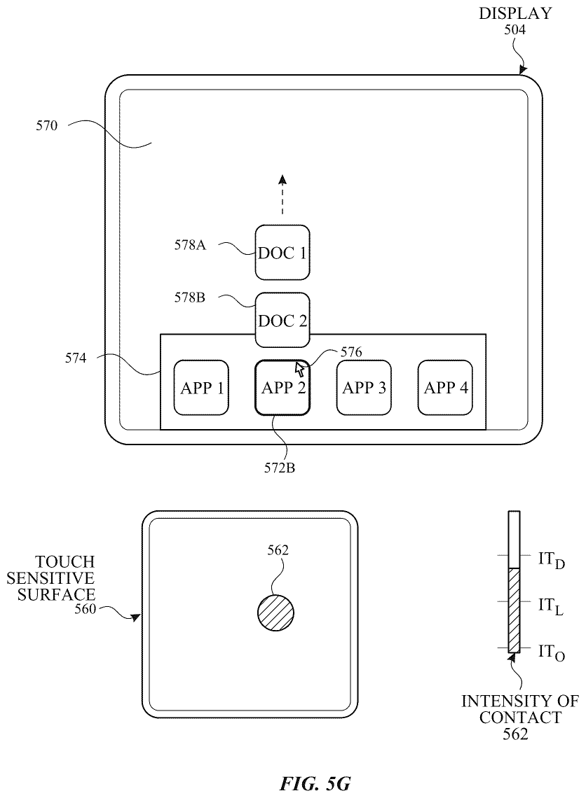

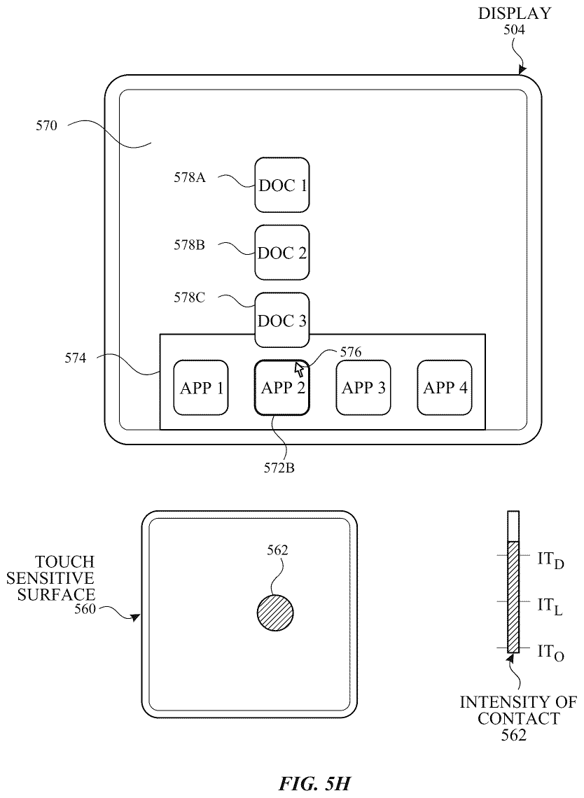

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 504 optionally execute any number of programs stored in memory 506 or storage, which optionally includes instructions to perform one or more of the methods and/or processes described herein (e.g., method 700). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIGS. 5, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D})”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D})”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D})”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as device 100, device 300, or device 500.

### User Interfaces and Associated Processes

### User Interfaces for Displaying a Transcript of a Content Item

Users interact with electronic devices in many different manners, including interacting with a media content application to view a transcript of a content item. In some embodiments, an electronic device displays the transcript in synchrony with the content item being played. In some embodiments, scrolling the transcript in accordance with a scrolling input includes decelerating the scrolling in response to a determination that a currently displayed portion of the transcript includes a portion of the transcript that corresponds to a current playback position of the content item. The embodiments described below provide a quick and efficient way of aligning display of the transcript to the current playback position without requiring the user to provide further inputs to precisely locate the portion of the transcript that corresponds to the current playback position, which enhances the operability of the device and makes the user-device interface more efficient. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

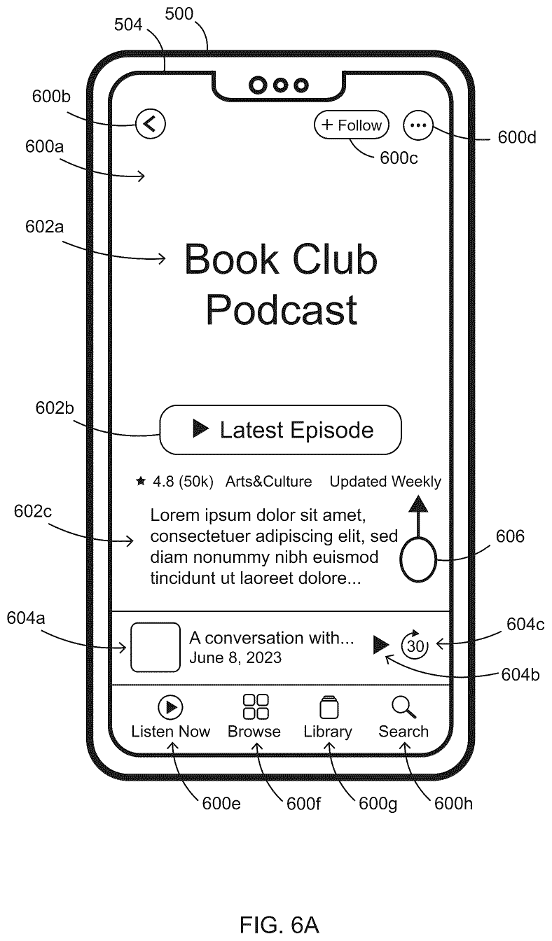

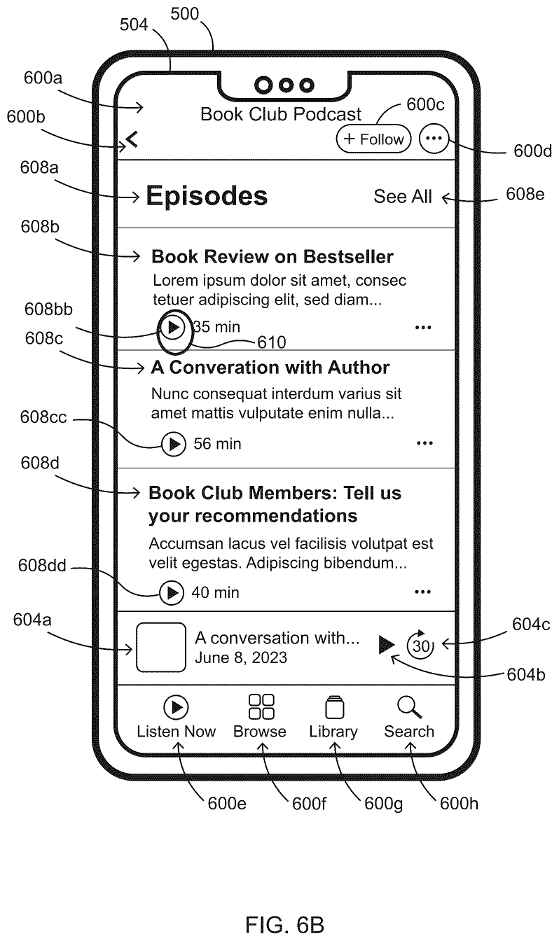

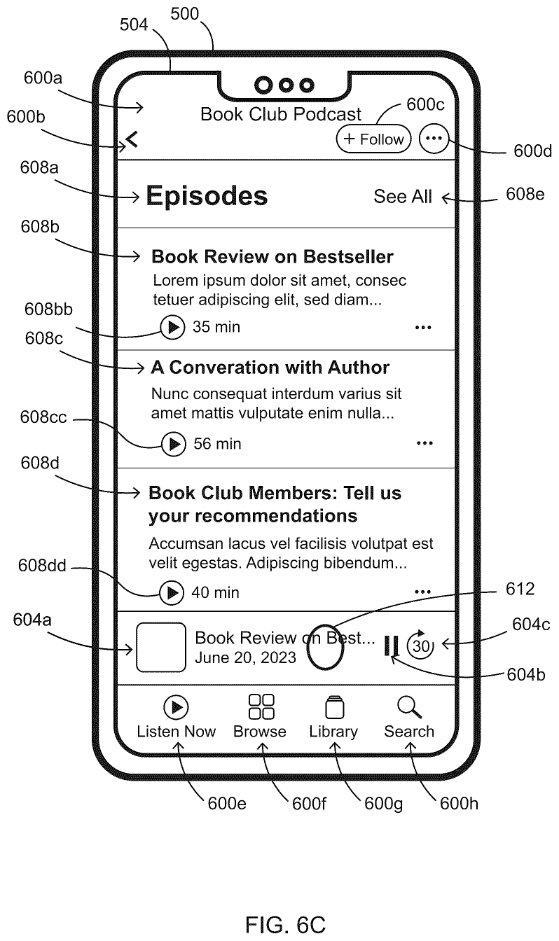

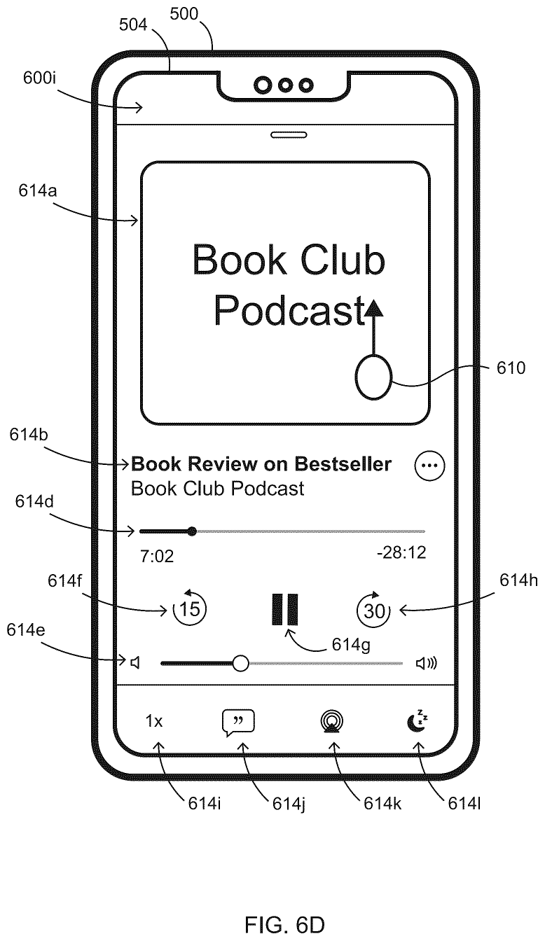

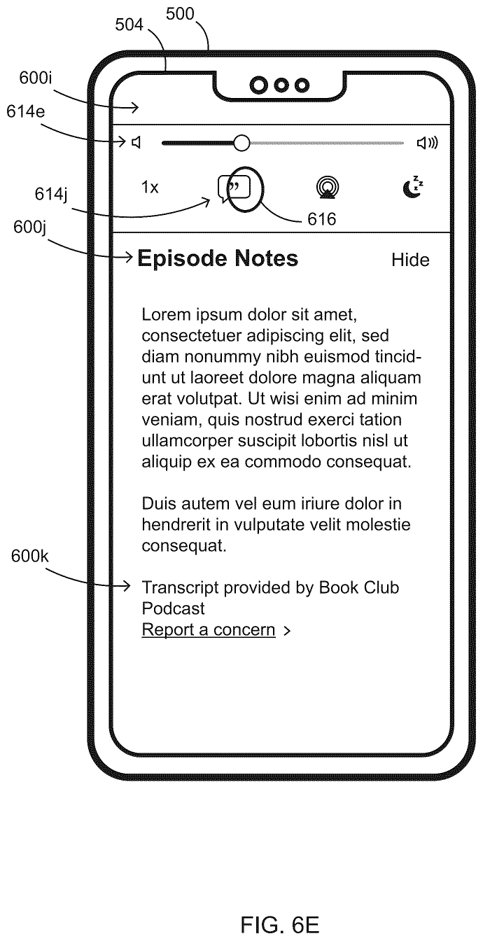

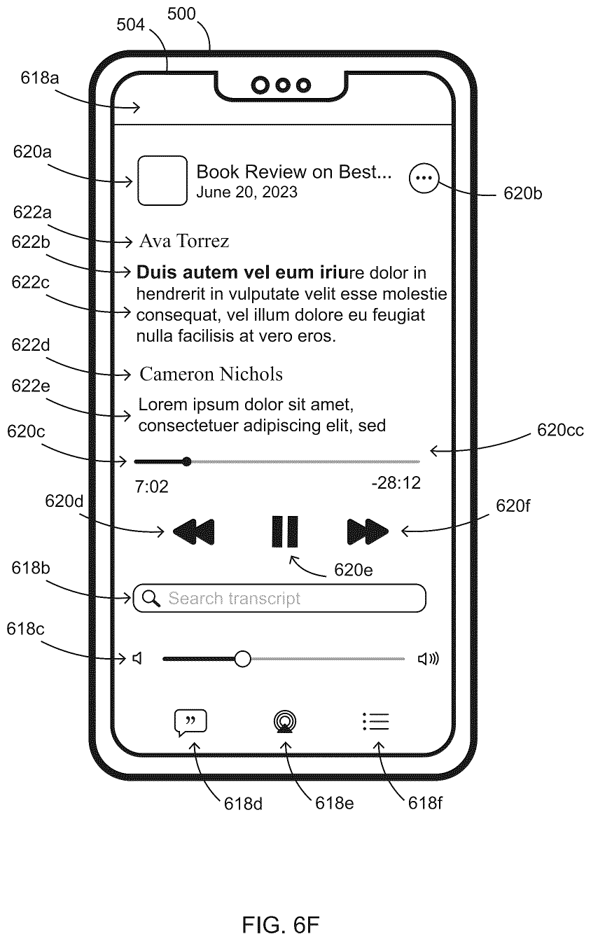

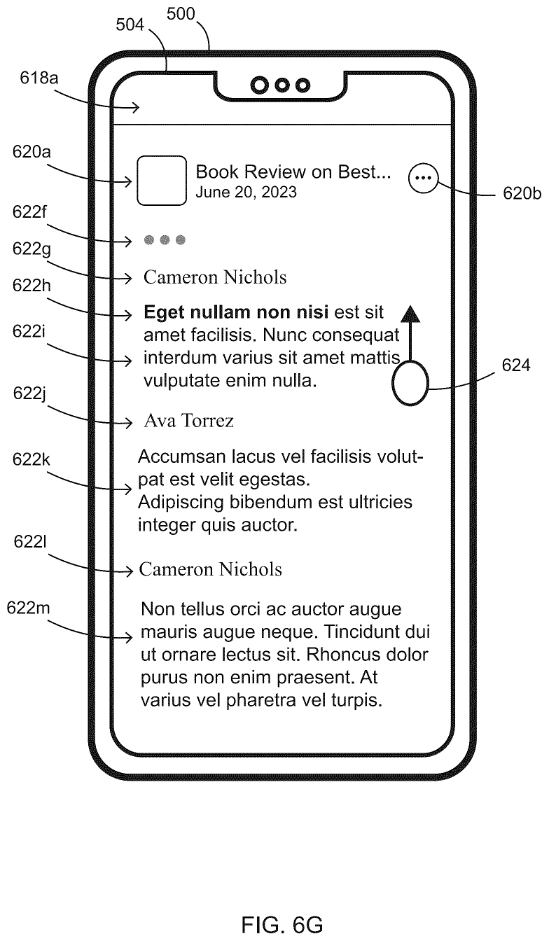

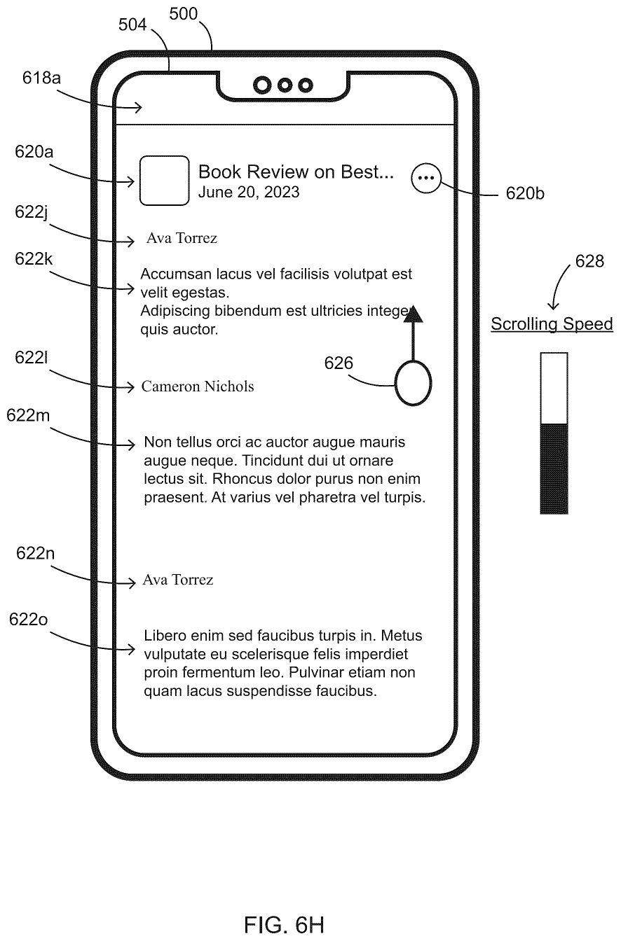

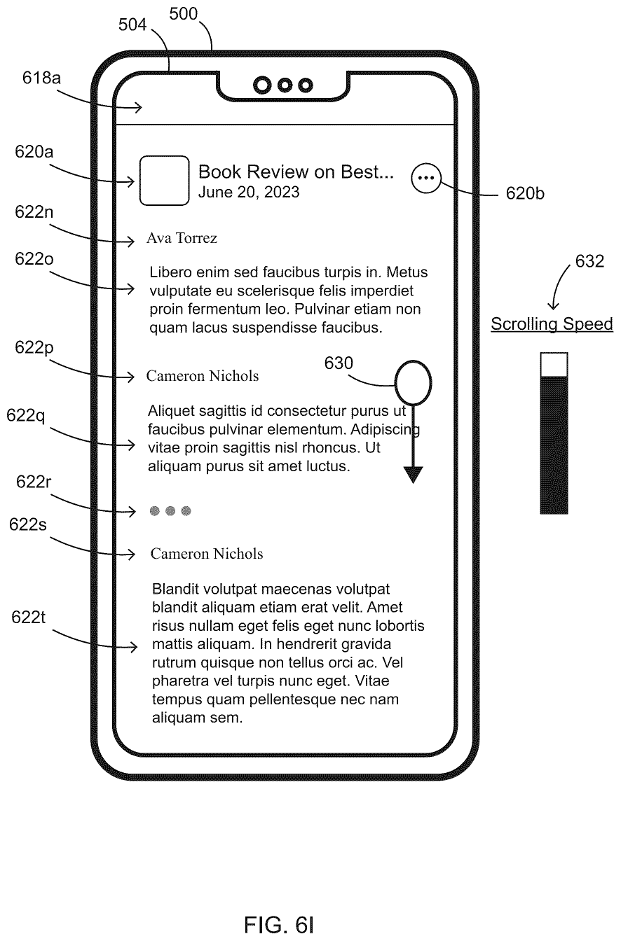

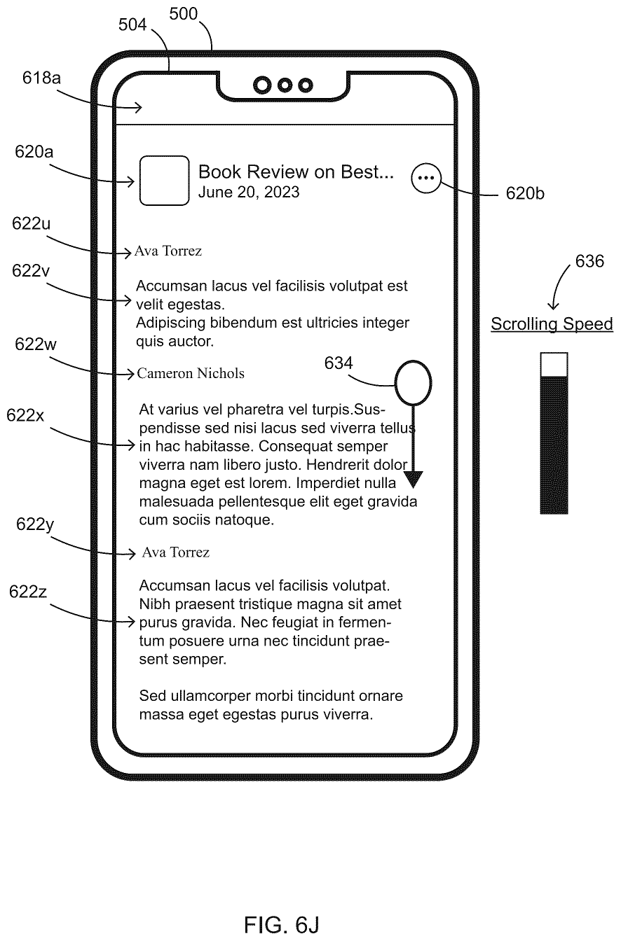

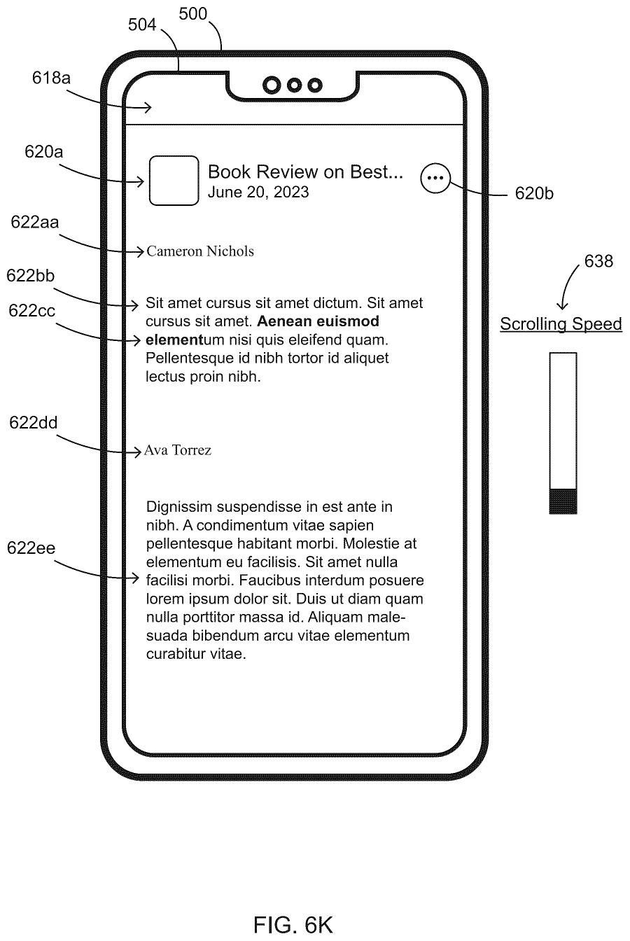

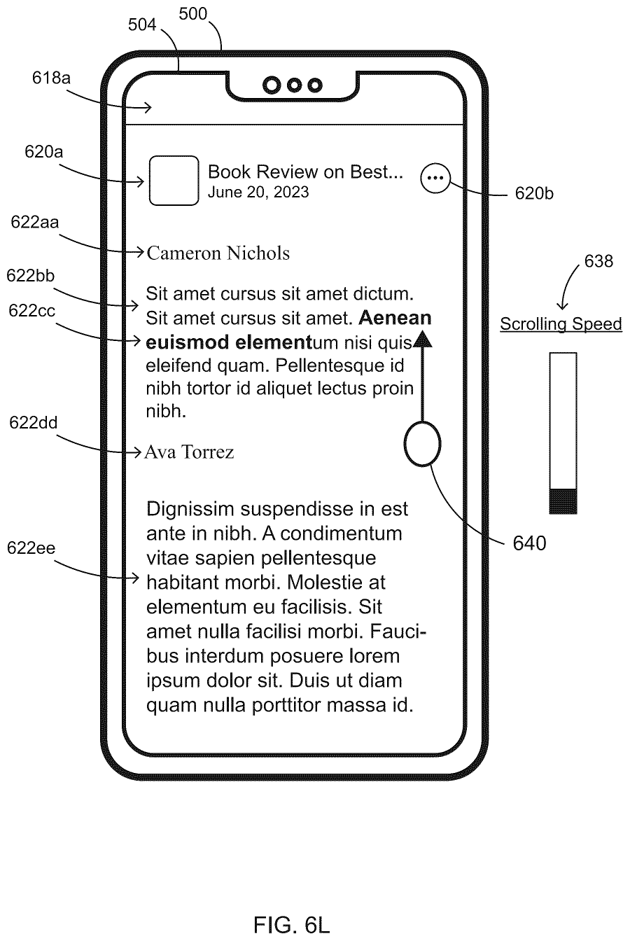

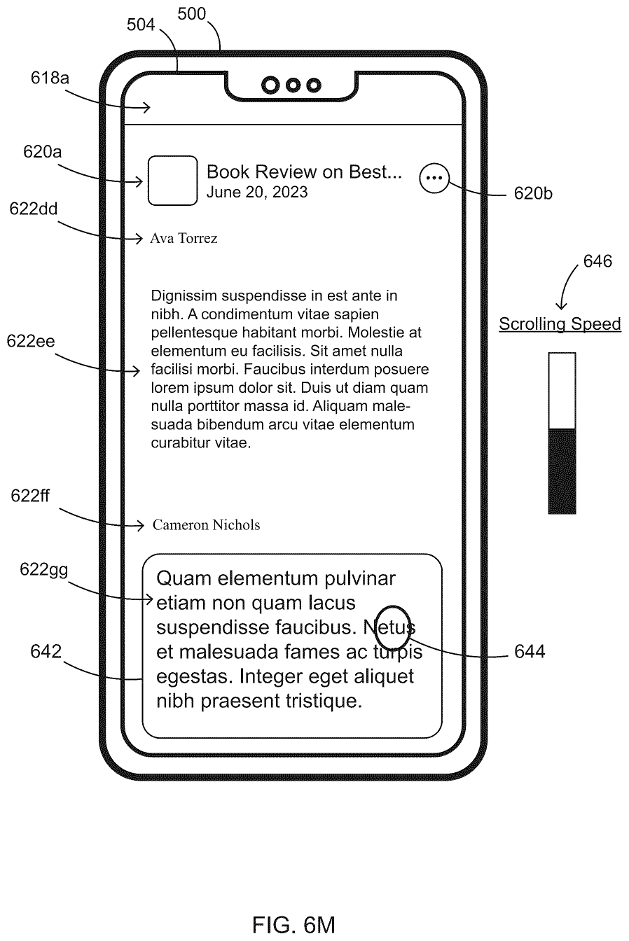

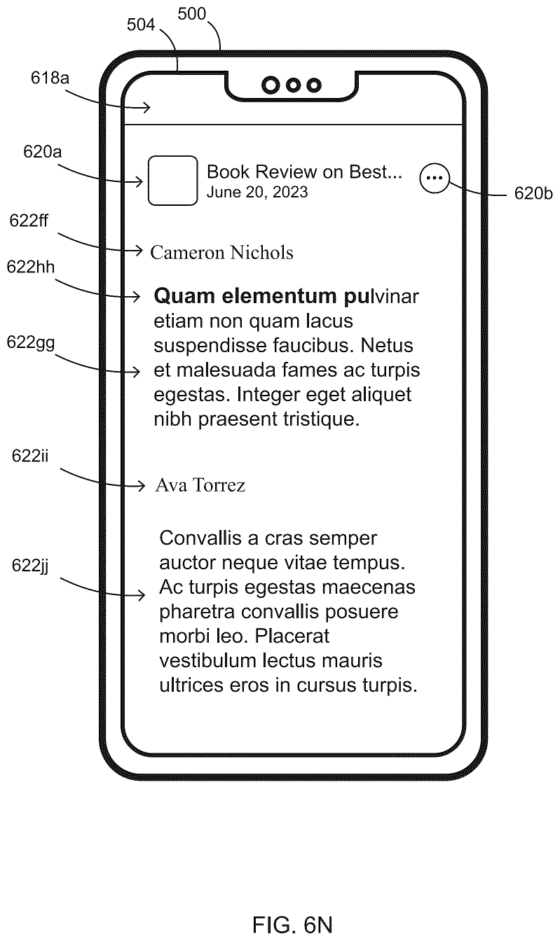

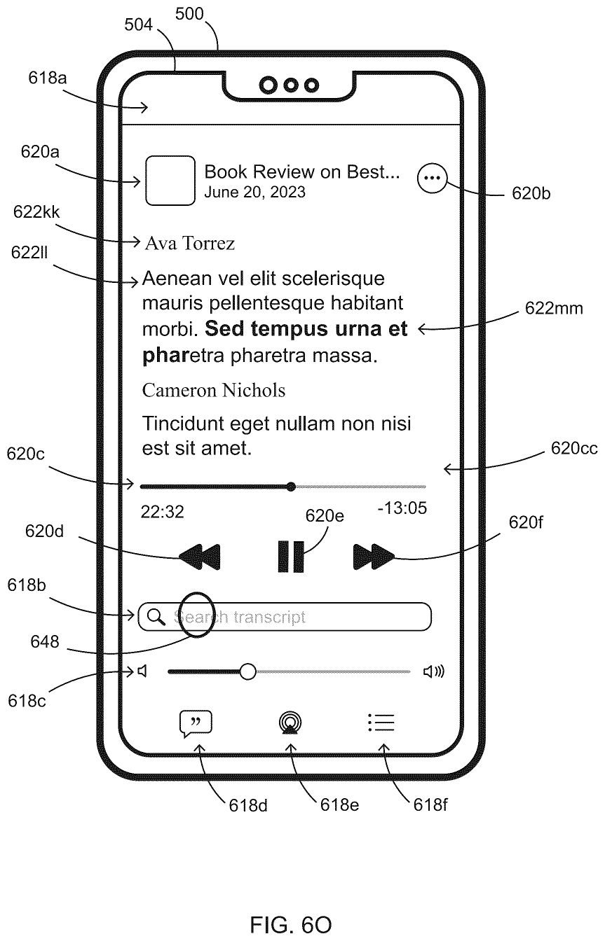

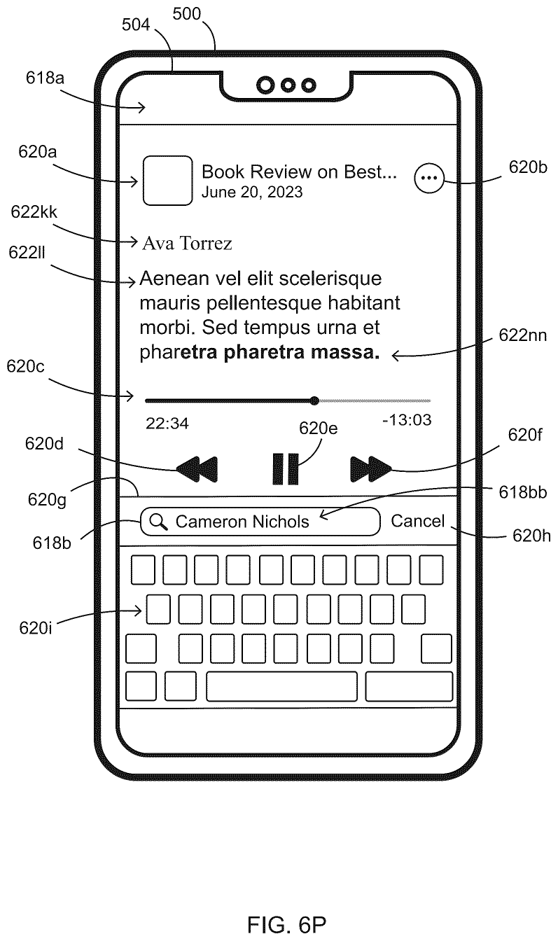

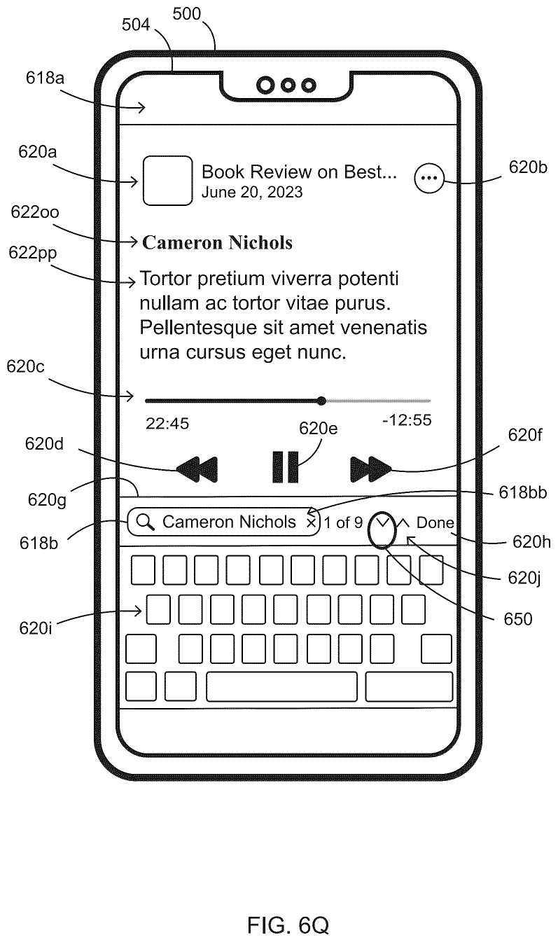

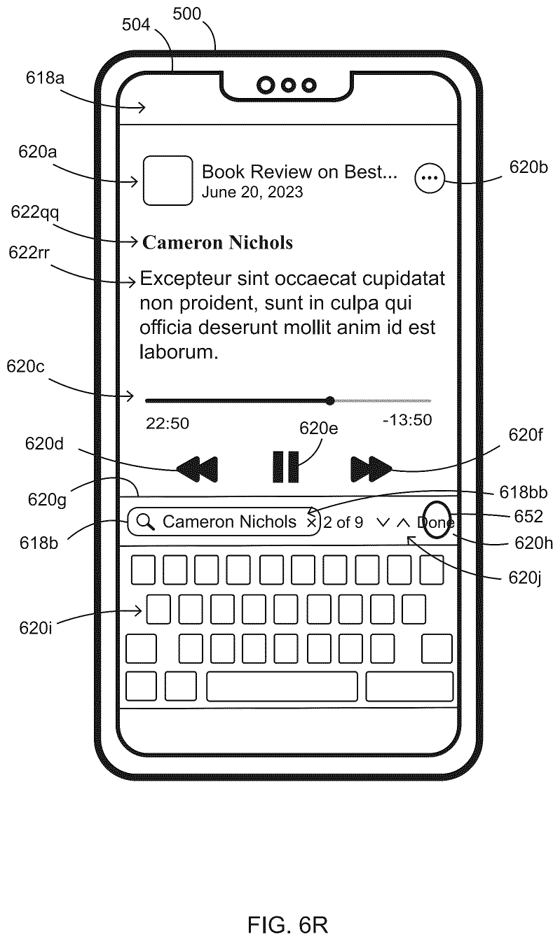

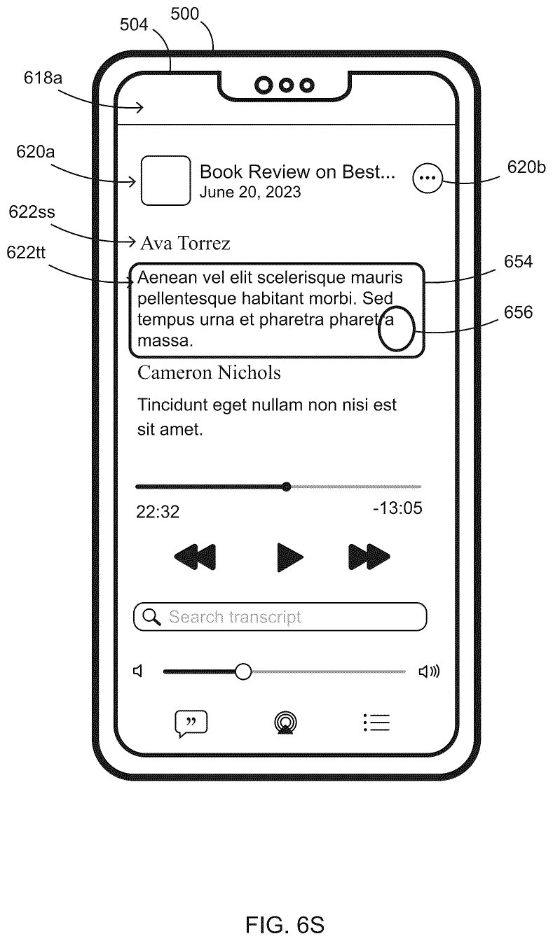

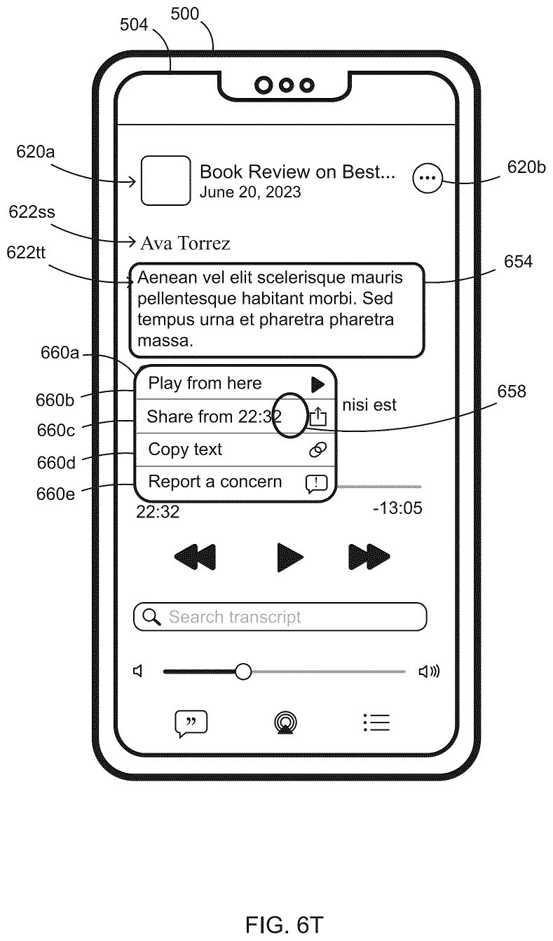

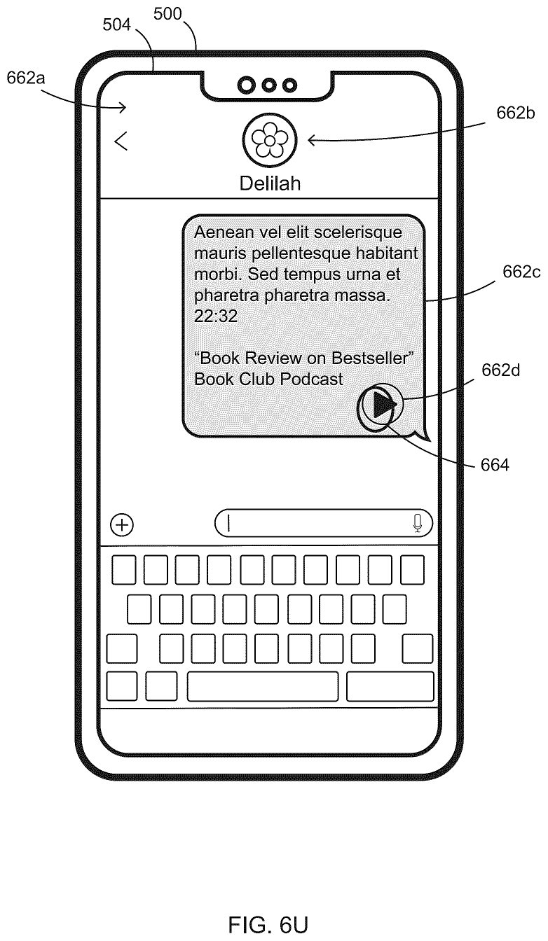

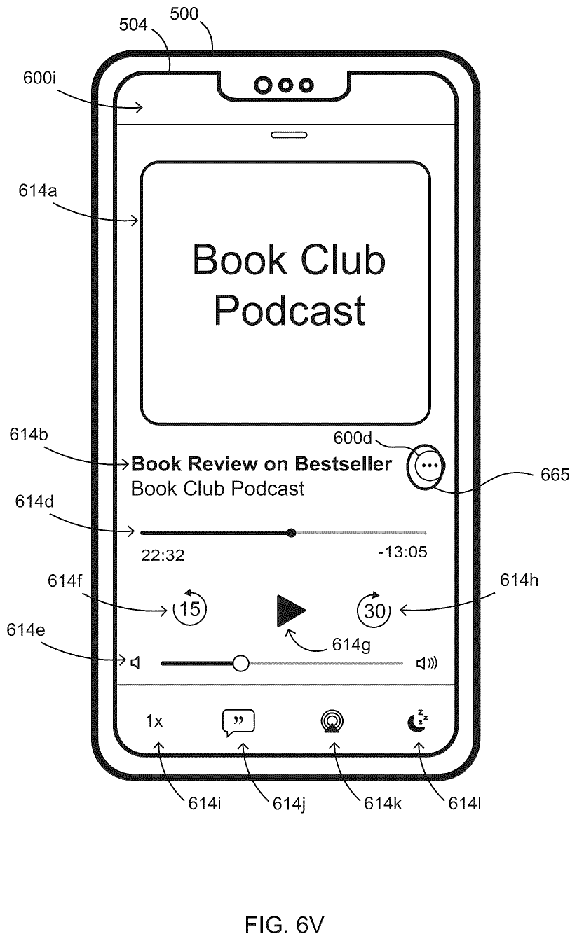

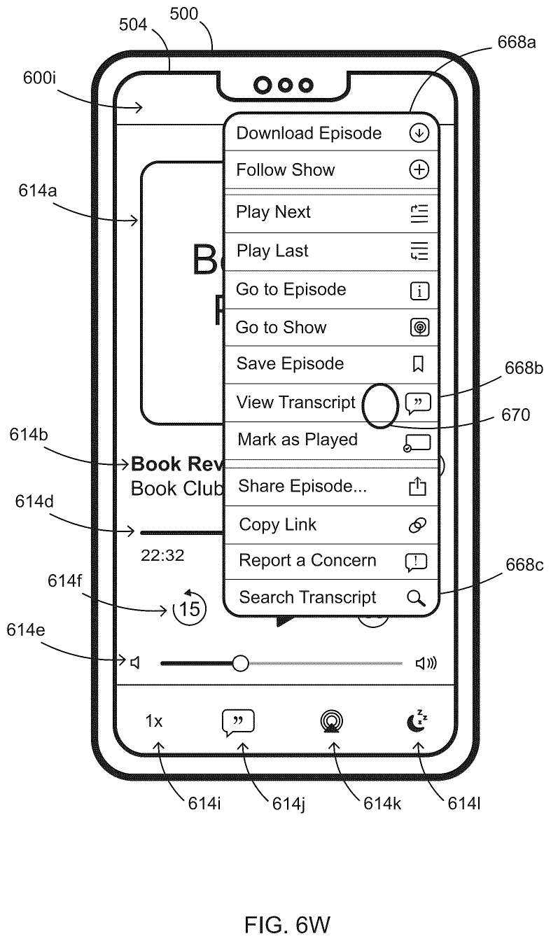

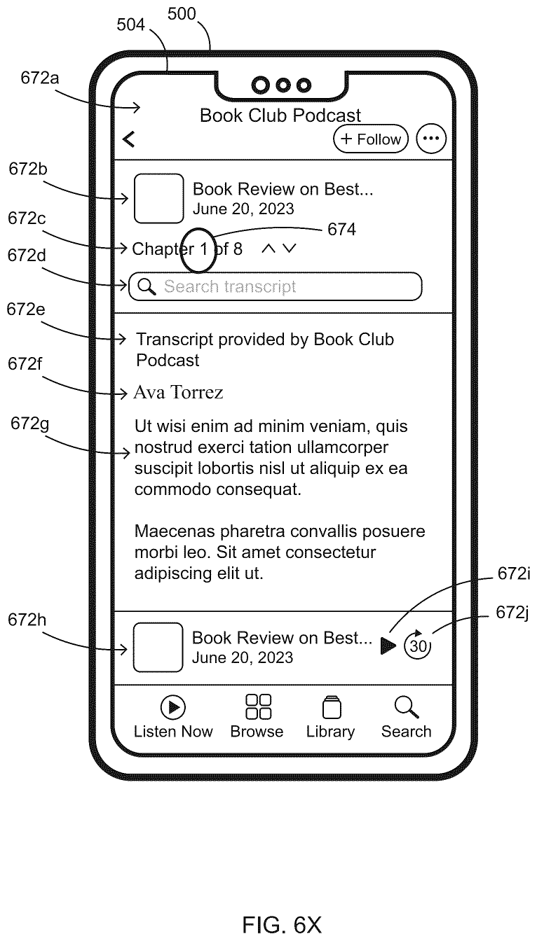

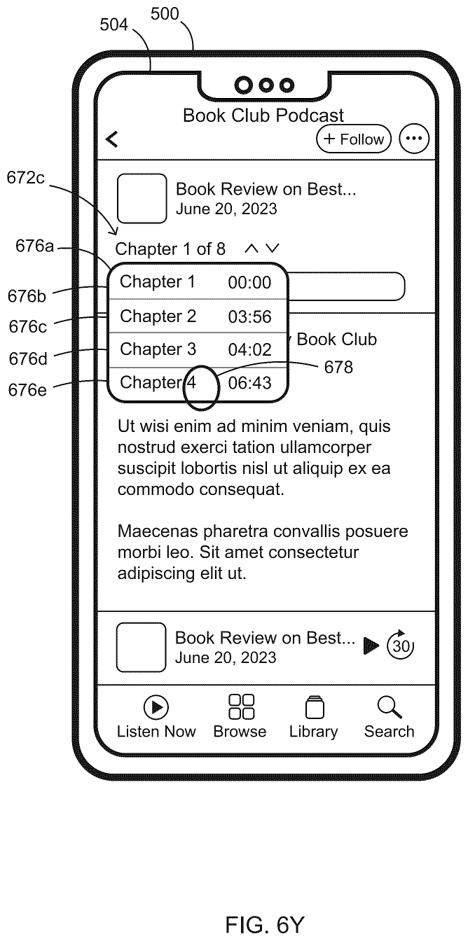

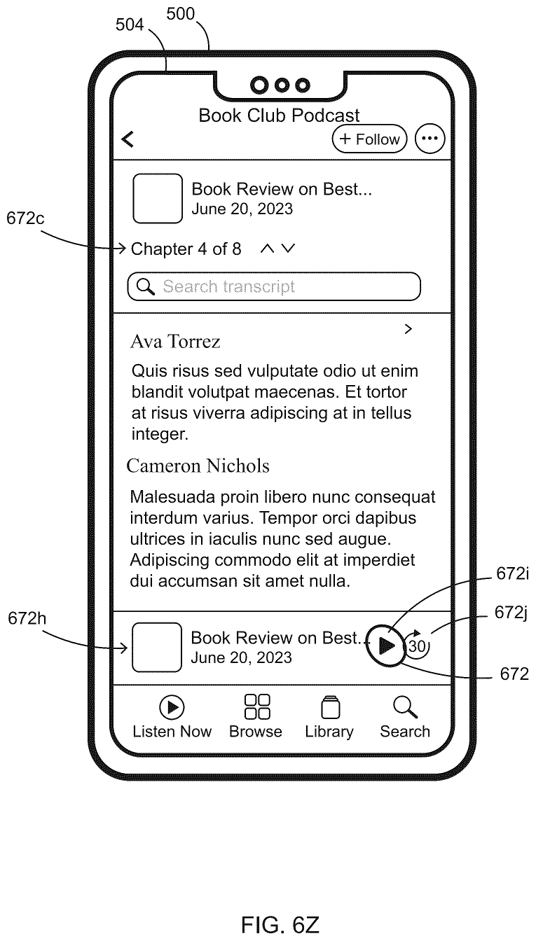

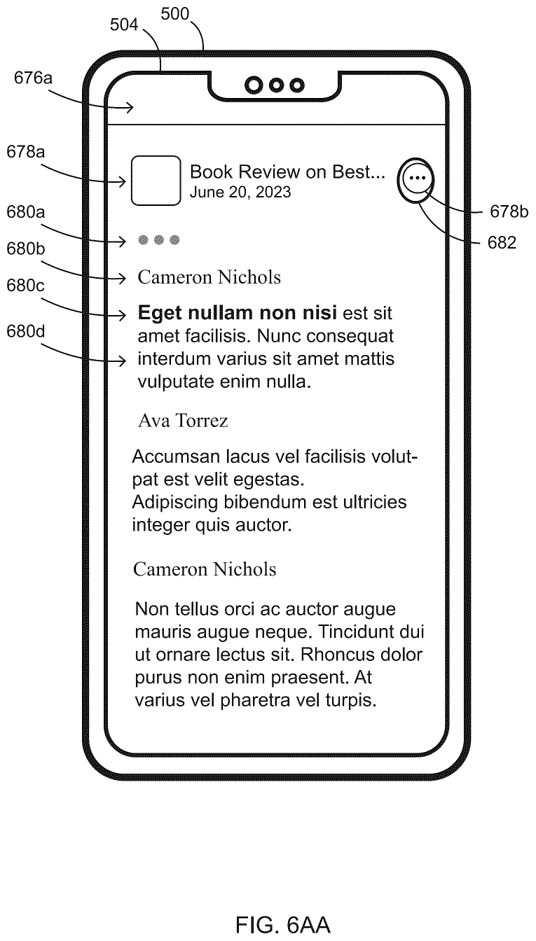

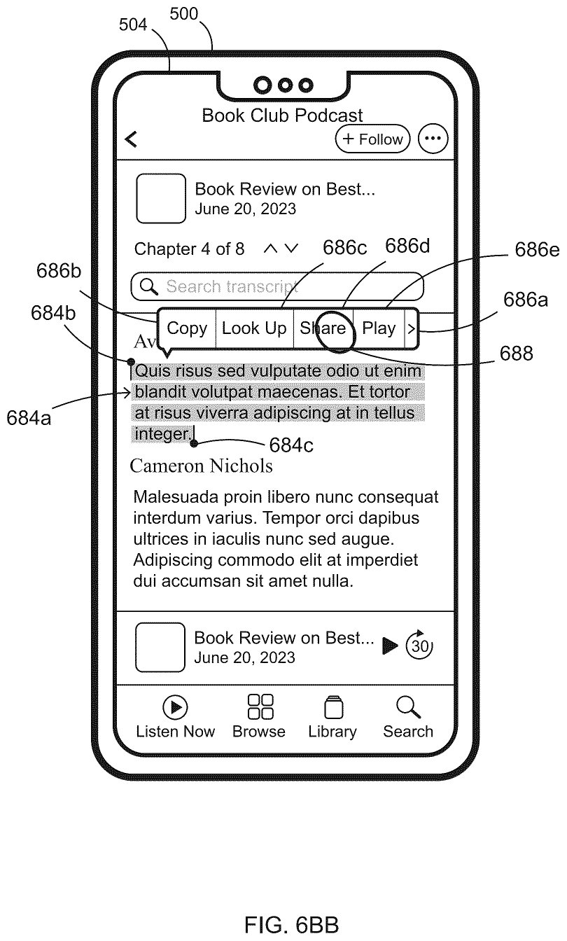

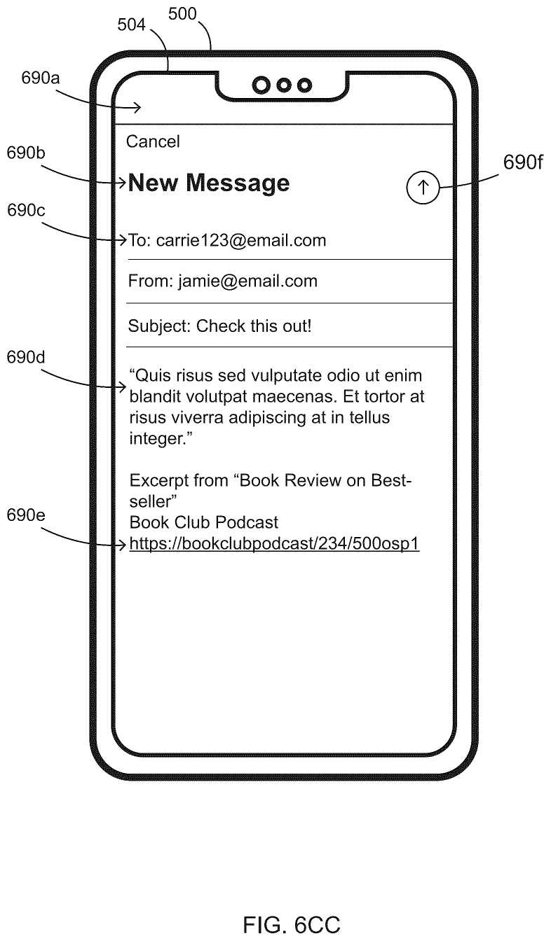

FIGS. 6A-6CC illustrate exemplary ways in which an electronic device decelerates scrolling a time-synchronized transcript of a content item according to some embodiments of the disclosure. The embodiments in these figures are used to illustrate the processes described below, including the processes described with reference to FIG. 7. Although FIGS. 6A-6CC illustrate various examples of ways an electronic device is able to perform the processes described below with respect to FIG. 7, it should be understood that these examples are not meant to be limiting, and the electronic device is able to perform one or more processes described below with reference to FIG. 7 in ways not expressly described with reference to FIGS. 6A-6CC.

FIG. 6A illustrates an electronic device 500 displaying a user interface 600a of a content application. In some embodiments, the user interface 600a is displayed via a display generation component 504. In some embodiments, the display generation component is a hardware component (e.g., including electrical components) capable of receiving display data and displaying a user interface. In some embodiments, examples of a display generation component include a touch screen display, a monitor, a television, a projector, a head-mounted display, an integrated, discrete, or external display device, or any other suitable display device.

As shown in FIG. 6A, the user interface 600a is a user interface of an audio streaming and media player application (e.g., podcast application). For example, the audio streaming and media player application presents podcasts. The podcast application optionally obtains podcast data that includes the audio file, transcript, hyperlinks, data defining the podcast, imagery, etc., from a server. The podcast application optionally requests, from the server through a network (e.g., local area network, cellular data network, wireless network, the Internet, wide area network, etc.), podcast data. The podcast application optionally stores the podcast data in a database of the electronic device 500. The podcast application optionally uses the podcast data stored in the database and/or other podcast data received from the server to provide podcast application features described herein (e.g., transcripts, searching, navigating chapters, etc.). In some embodiments, the server can be a computing device, or multiple computing devices, configured to store, generate, and/or provide podcast data to various user devices (e.g. electronic device 500), as described herein. For example, the functionality described herein with reference to the server can be performed by a single computing device or can be distributed amongst multiple computing devices. It is understood that although the embodiments described herein are directed to podcasts, such functions and/or characteristics, optionally apply to other content including audiobooks, music, recorded news, recorded performances, speeches, and/or other spoken/sung words.

As shown in FIG. 6A, the electronic device 500 presents a user interface 600a (e.g., of a podcast application installed on electronic device 500) using display generation component 504. In FIG. 6A, the user interface 600a includes podcast user interface element 602a of a podcast (e.g., “Book Club Podcast”). Podcast user interface element 602a includes a description (e.g., text 602c) of and/or an image associated with the podcast; and a user interface element 602b that, when selected, causes the electronic device 500 to play a content item of the podcast (e.g., the latest episode of the podcast). The user interface 600a also includes a content player user interface element 604a associated with a previously played content item. In some embodiments, the previously played content item is an episode of the “Book Club Podcast”, a podcast different from the “Book Club Podcast,” or another content item optionally of a type different from a podcast. In FIG. 6A, the content player user interface element 604a includes a description of and/or an image of the previously-played content item; a play option 604b that, when selected, causes the electronic device 500 to play the respective content item; and a fast forward option 604c that, when selected, causes the electronic device 500 to fast forward playing the respective content item by a predetermined time (e.g., 10, 20, 30, 40, 50, or 60 seconds).

User interface 600a also includes the following selectable options: navigation option 600b that, when selected, causes the electronic device 500 to navigate to the previously displayed page of the user interface 600a; follow option 600c that, when selected, causes the electronic device 500 to automatically receive notifications for the podcast, such as notifications when new episodes of the podcast are released; and menu option 600d that, when selected, causes the electronic device 500 to display one or more options to perform one or more actions associated with the “Book Club Podcast” as will be described below with reference to FIGS. 6V-6W and 6AA

In FIG. 6A, the user interface 600a also includes navigation options including option 600e that, when selected, causes the electronic device 500 to navigate to a “Listen Now” user interface that includes podcasts that a user account associated with the electronic device 500 is currently or recently listening to and/or currently following. The “Listen Now” user interface optionally also includes recommended podcasts and/or a list of podcasts the user account previously listened to. The user interface 600a also includes option 600f that, when selected, causes the electronic device 500 to navigate to a “Browse” user interface that includes a curated listing of podcasts, such as recent, popular, featured podcasts, and/or podcasts of a specific category (e.g., Politics, True Crime, etc.). The user interface 600a also includes option 600g that, when selected, causes the electronic device 500 to navigate to a “Library” user interface that includes a listing of podcasts that the user account associated with the electronic device 500 is following and/or podcast episodes the user account has saved. The user interface 600a also includes option 600h that, when selected, causes the electronic device 500 to perform a search operation of a podcast database that comprises searching for a particular podcast corresponding to entered search text.

In some embodiments, user interface 600a includes a listing of available episodes for the podcast. For example, in FIG. 6A, the electronic device 500 receives user input 606 (e.g., a swipe contact on a touch-sensitive surface and/or a voice input from the user) corresponding to a request to navigate (e.g., scroll) to the listing of episodes of the “Book Club Podcast” in user interface 600a. In response to receiving the user input 606, the electronic device 500 scrolls the user interface 600a to reveal a listing of episodes of the “Book Club Podcast” in user interface 600a, as shown in FIG. 6B.

FIG. 6B illustrates the user interface 600a including label 608a titled “Episodes” and “see all” option 608e that, when selected, causes the electronic device 500 to display all available episodes in an organized, categorized manner. User interface 600a also includes podcast episode user interface elements 608b, 608c, and 608d. The podcast episode user interface elements include a respective user interface element (e.g., user interface elements 608bb, 608cc, and 608dd) that, when selected, causes the electronic device 500 to play the respective podcast episode. For example, electronic device 500 receives user input 610 (e.g., a contact on a touch-sensitive surface, actuation of a physical input device of the electronic device 500 or in communication with the electronic device 500, and/or a voice input from the user) corresponding to selection of the user interface element 608bb, and in response to receiving user input 610, the electronic device 500 plays the respective content item (e.g., podcast episode titled “Book Review on Bestseller”), as shown via content player user interface element 604a in FIG. 6C.

FIG. 6C illustrates content player user interface element 604a including a description of and/or an image associated with the podcast episode titled “Book Review on Bestseller”; a pause option 604b that, when selected, causes the electronic device 500 to pause playing the respective content item; and a fast forward option 604c that, when selected, causes the electronic device 500 to skip the playback position of the respective content item ahead by a predetermined time (e.g., 10, 20, 30, 40, 50, or 60 seconds). As shown in FIG. 6C, the content player user interface element 604a is displayed as partially expanded. In some embodiments, when the electronic device 500 displays the content player user interface element 604a fully expanded, the content player user interface element 604a includes additional content and/or selectable options than when displayed as partially expanded. For example, in FIG. 6C, the electronic device 500 receives user input 612 (e.g., a contact on a touch-sensitive surface, actuation of a physical input device of the electronic device 500 or in communication with the electronic device 500, and/or a voice input from the user) corresponding to selection of the content player user interface element 604a, and in response to receiving user input 612, the electronic device 500 displays user interface 600i including a fully expanded content player user interface element 614a, as shown in FIG. 6D. User interface 600i is a user interface of the podcast application.

FIG. 6D illustrates the fully expanded content player user interface element 614a as including an image associated with the podcast, the title 614b of the podcast episode, and the following selectable user interface elements and/or options: a seek bar option 614d that, when selected, causes the electronic device 500 to scrub to a selected time in the respective content item (e.g., podcast episode); a rewind option 614f that, when selected, causes the electronic device 500 to move the playback position of the respective content item backwards by a predetermined time (e.g., 10, 15, 20, 30, 40, 50, or 60 seconds); a fast forward option 615h that, when selected, causes the electronic device 500 to move the playback position of the respective content item forwards by a predetermined time (e.g., 10, 15, 20, 30, 40, 50, or 60 seconds); a pause option 614g that, when selected, causes the electronic device 500 to pause playing the respective content item; and a volume user interface element 614e that, when selected, causes the electronic device 500 to adjust the volume of the content item to a selected level. In FIG. 6D, user interface 600i also includes the following selectable options: a playback speed option 614i that, when selected, causes the electronic device 500 to adjust the playback speed of the content item; a time-synchronized transcript option 614j that, when selected, causes the electronic device 500 to display the transcript of the content item in synchrony with the content item being played as will be discussed below with reference to FIGS. 6F-6N; a streaming option 614k that, when selected, causes the electronic device 500 to stream audio and/or video of the content item to a second electronic device (e.g., television, speakers, and/or the like), different from the electronic device 500; and a sleep timer option 614l that, when selected, causes the electronic device 500 to stop playing the content item after a selected amount of time.

In some embodiments, content player user interface element 614a includes more information about the content item. For example, in FIG. 6D, the electronic device 500 receives user input 610 (e.g., a swipe contact on a touch-sensitive surface and/or a voice input from the user) corresponding to a request to navigate (e.g., scroll) to view additional information about the content item in content player user interface element 614a. In response to receiving the user input 610, the electronic device 500 displays additional information about the content item (e.g., text 600j) including an indication of the provider of the transcript of the content item (e.g., indication 600k), as shown in FIG. 6E.

As mentioned above, content player user interface element 614a includes time-synchronized transcript option 614j that, when selected, causes the electronic device 500 to display the transcript of the content item in synchrony with the content item being played. For example, in FIG. 6E, the electronic device 500 receives user input 616 (e.g., a contact on a touch-sensitive surface, actuation of a physical input device of the electronic device 500 or in communication with the electronic device 500, and/or a voice input from the user) corresponding to selection of the time-synchronized transcript option 614j, and in response to receiving user input 616, the electronic device 500 displays user interface 618a, as shown in FIG. 6F. User interface 618a is a user interface of the podcast application.

FIG. 6F illustrates the electronic device 500 displaying the transcript of the content item in synchrony with the content item being played concurrently with the content player user interface element. For example, the transcript of the content item includes time-synchronized portions 622b, 622c, and 622e (e.g., spoken words) of the transcript. In FIG. 6F, portion 622b is a portion of the transcript corresponding to the portion of the content item that the electronic device 500 is currently playing and portions 622c and 622e are portions of the transcript of the content item corresponding to portions of the content item that will play after the portion of the content item the electronic device 500 is currently playing. As shown in FIG. 6F, the electronic device 500 displays portion 622b of the transcript of the content item that corresponds to the portion of the content item the electronic device 500 is currently playing with a visual characteristic (e.g., bolded) different from visual characteristics of portions of the transcript corresponding to portions of the content item the electronic device 500 is not currently playing, such as portions 622c and 622e. FIG. 6F further illustrates that the electronic device 500 displays indications 622a and 622d of the speaker of respective portions of the transcript. In some embodiments, the electronic device 500 displays the indications 622a and/or 622d of the speaker in a manner different from the manner in which the electronic device 500 displays portions 622b, 622c, and/or 622e of the transcript corresponding to the spoken words of the content item. For example, and as shown in FIG. 6F, the electronic device 500 displays indications 622a and 622d identifying the respective speakers with text having a size larger than the text of portions 622b, 622c, and 622e corresponding to the spoken words of the content item. It is understood that although FIG. 6F described herein includes displaying indications of speaker(s) and/or portions of the transcript in bold and/or in a larger size, any number of visual characteristics are optionally applied as described with reference to method 700.

As shown in FIG. 6F, the electronic device 500 displays the content player user interface element including one or more similar user interface elements, information, and options as previously described with reference to the content player user interface element 614a in FIG. 6D while displaying the time-synchronized transcript. In some embodiments, the user interface 618a includes search user interface element 618b that, when selected, causes the electronic device 500 to perform search operation within the transcript as will be described below with reference to FIGS. 60-6R. In FIG. 6F, the user interface 618a also includes a content item queue option that, when selected, causes the electronic device 500 to display a “Queue” user interface that includes a queue of content items to be played including the content item currently being played. The “Queue” user interface optionally includes selectable options to control the playback order of the queue of content items.

In some embodiments, the electronic device 500 displays the content player user interface element 620cc including the selectable user interface elements 620c, 620d, 620c, 620f, 618b, 618c, 618d, 618c, and 618f for a predetermined amount time (e.g., 5, 10, 20, 30, 40, or 60 seconds) if the electronic device 500 does not receive user input corresponding to selection of one or more of the selectable user interface elements. For example, after the predetermined amount of time has elapsed, the electronic device 500 ceases to display the content player user interface element 620cc including the selectable user interface elements 620c, 620d, 620e, 620f, 618b, 618c, 618d, 618c, and 618f, as shown in FIG. 6G.

FIG. 6G illustrates the electronic device 500 displaying the transcript of the content item in synchrony with the content item being played without displaying the content player user interface element 620cc that was displayed in FIG. 6F. As illustrated in FIG. 6G, the electronic device 500 continues to play the content item while displaying the time-synchronized transcript. The electronic device 500 displays an indication 622f of a non-transcribable portion (e.g., instrumental music, non-vocals, or dynamic advertisements) of the content item. The electronic device 500 also displays indications 622g, 622j, and 622l of the speaker of respective portions of the transcript and time-synchronized portions 622h, 622i, 622k, and 622m (e.g., spoken words) of the transcript. In FIG. 6G, portion 622h is a portion of the transcript corresponding to the portion of the content item that the electronic device 500 is currently playing and portions 622i, 622k, and 622m are portions of the transcript corresponding to the portions of the content item that will play after the portion of the transcript of the content item the electronic device 500 is currently playing. As shown in FIG. 6G, the electronic device 500 displays portion 622h of the transcript of the content item that corresponds to the portion of the content item that the electronic device 500 is currently playing with a visual characteristic (e.g., bolded) different from visual characteristics of portions of the transcript corresponding to portions of the content item the electronic device 500 is not currently playing, such as portions 622i, 622k, and 622m. In some embodiments, application of the visual characteristic advances as the electronic device 500 continues to play the content item. For example, as portions (e.g., words and/or phrases) of the transcript are spoken (e.g., played back), the electronic device 500 applies the visual characteristic to the text of the portions of the transcript corresponding to the words and/or phrases being played back. FIG. 6G illustrates portion 622i of the transcript corresponding to a portion of the content item that has yet to be played at the current playback position with a second visual characteristic (e.g., not bolded), different from the visual characteristic of the transcript of the content item that corresponds to the portion of the content item that the electronic device 500 is currently playing, such as portion 622h.

In some embodiments, the electronic device 500 provides an ability to scroll the transcript in accordance with a speed, velocity, and/or acceleration of movement of a point of contact on a touch-sensitive surface or by a deceleration profile in accordance with a determination that a currently displayed portion of the transcript includes a portion of the transcript that corresponds to a current playback position of the content item. For example, in FIG. 6G, the electronic device 500 receives user input 624 (e.g., a swipe contact on a touch-sensitive surface and/or a voice input from the user) corresponding to a request to scroll the transcript in user interface 618a in an upwards direction. In response to receiving the user input 624, the electronic device 500 scrolls the transcript in an upwards direction to reveal an additional portion of the transcript at the bottom of the user interface 618a, such as portion 6220 and an indication 622n of the speaker of the portion 6220 as shown in FIG. 6H. Portion 6220 corresponds to a portion of the content item that will play after the portion of the content item the electronic device 500 is currently playing. As shown in FIG. 6H, while scrolling the transcript in accordance with the user input 624 (of FIG. 6G) and displaying portions 622k, 622m, and 6220 of the transcript and indications 622j, 622l, and 622n of the respective speakers of the respective portions of the transcript, the electronic device 500 displays, as shown in FIG. 6I, the portions 6220, 622q, and 622t of the transcript with text having a size smaller than the size of the text of the respective portions of the transcript (e.g., portions 622h, 622k, and 622m) when not scrolling the transcript, as shown in FIG. 6G. As shown in FIG. 6I, indications of the speaker, such as indications 622n, 622p, and 622s, and an indication 622r of a non-transcribable portion (e.g., instrumental music, non-vocals, or dynamic advertisements) of the content item are displayed, by the electronic device 500, with text having the smaller size similar to portions 6220, 622q, and 622t of the transcript.

FIG. 6H also illustrates the speed in which the electronic device 500 scrolls the transcript in accordance with the user input 624 in FIG. 6G, as shown by scrolling speed indicator 628 having a first speed. In some embodiments, the electronic device 500 changes the speed of scrolling through portions of the transcript in response to detecting changes of the speed of movement of the scrolling input (e.g., detecting the point of contact moving at faster or slower speeds). For example, in FIG. 6H, the electronic device 500 receives user input 626 (e.g., a swipe contact on a touch-sensitive surface) corresponding to a request to scroll the transcript in user interface 618a in an upwards direction at a greater speed than the scrolling speed performed in response to input 624. In some embodiments, the electronic device 500 detects that user input 626 includes movement of the point of contact at a speed greater than the speed of movement of the point of contact associated with the user input 624 in FIG. 6G. In some embodiments, in response to detecting movement of the point of contact at a greater speed, the electronic device 500 scrolls through portions of the transcript at an increased scrolling speed as shown by scrolling speed indicator 632 in FIG. 6I. The increased scrolling speed is greater than the first speed corresponding to scrolling speed indicator 628 in FIG. 6H.

In some embodiments, while the electronic device 500 scrolls through portions of the transcript, the electronic device 500 displays additional portions of the transcript from the bottom of user interface 618a, such as portions 622q and 622t, and indications 622p, 622r, and 622s, as shown in FIG. 6I. The portions 622q and 622t correspond to portions of the content item that will play after the portion of the content item the electronic device 500 is currently playing. The electronic device 500 also displays portions 622q and 622t and indications 622p, 622r, and 622s in FIG. 6I with text having a size smaller than the size of the text of the respective portions of the transcript (e.g., portions 622h, 622k, 622m, and indications 622g, 622j, and 622l) when not scrolling the transcript, as shown in FIG. 6G.

In FIG. 6I, while scrolling the transcript in accordance with the user input 626 and displaying the respective portions of the transcript, the electronic device 500 receives user input 630 (e.g., a swipe contact on a touch-sensitive surface) corresponding to a request to scroll the transcript in user interface 618a in a downwards direction at a greater speed than the speed of scrolling in response to receiving input 624. In response to receiving the user input 630, the electronic device 500 scrolls through portions of the transcript with a speed represented by scrolling speed indicator 636 in FIG. 6J. In some embodiments, while the electronic device 500 scrolls through portions of the transcript, the electronic device 500 displays respective portions of the transcript from the top of user interface 618a, such as portions 622v, 622x, 622z, and indications 622u, 622w, and 622y of the respective speakers of portions 622v, 622x, 622z, as shown in FIG. 6J. The portions 622v, 622x, 622z correspond to portions of the content item that will play after the portion of the content item the electronic device 500 is currently playing.

In some embodiments, the electronic device 500 scrolls the transcript based on a deceleration profile in accordance with a determination that a currently displayed portion of the transcript includes a portion of the transcript that corresponds to a current playback position of the content item. For example, in FIG. 6J, while scrolling the transcript in accordance with the user input 630 and displaying the respective portions of the transcript, the electronic device 500 receives user input 634 (e.g., a swipe contact on a touch-sensitive surface) corresponding to a request to scroll the transcript in user interface 618a in a downwards direction. In response to receiving the user input 634, the electronic device 500 determines that scrolling the transcript includes displaying a portion of the transcript that corresponds to a current playback position of the content item, such as shown by portion 622cc in FIG. 6K. In accordance with the determination that scrolling the transcript includes displaying a portion of the transcript that corresponds to a current playback position of the content item (e.g., portion 622cc), the electronic device 500 scrolls the transcript based on a deceleration profile as described with reference to method 700. Scrolling based on a deceleration profile includes decelerating by an amount while displaying the portion of the transcript that corresponds to the current playback position of the content item. Decelerating by an amount includes dampening the scrolling motion to an amount less than an amount associated with scrolling prior to displaying the portion of the transcript that corresponds to the current playback position of the content item. For example, the electronic device 500 decelerates scrolling through portions of the transcript as shown in the decreased scrolling speed from the second speed shown by scrolling speed indicator 636 in FIG. 6J to a third speed, less than the second speed, shown by scrolling speed indicator 638 in FIG. 6K.

As illustrated in FIG. 6K, while the electronic device 500 scrolls through portions of the transcript, the electronic device 500 displays respective portions of the transcript of user interface 618a, such as portions 622bb, 622cc, and 622ee, as shown in FIG. 6K. For example, portion 622bb is a portion of the transcript corresponding to the portion of the content item that the electronic device 500 has already played. Portion 622ee is a portion of the transcript corresponding to the portion of the content item that will play after the portion of the content item the electronic device 500 is currently playing (e.g., portion 622cc). As shown in FIG. 6K, the electronic device 500 displays portion 622cc of the transcript of the content item that corresponds to the portion of the content item that the electronic device 500 is currently playing with a visual characteristic (e.g., bolded), different from visual characteristics of portions of the transcript corresponding to portions of the content item the electronic device 500 is not currently playing, such as portions 622bb and 622cc.

In some embodiments, decelerating scrolling while displaying the portion of the transcript that corresponds to the current playback position of the content item includes decelerating to a stop or dampened motion at which to “snap” to the portion of the content item that the electronic device 500 is currently playing, such as portion 622cc. In some embodiments, the electronic device 500 also displays a portion of the transcript that the electronic device 500 has already played, such as portion 622bb, as shown in FIG. 6K. In some embodiments, if the currently displayed portion does not correspond to the current playback position of the content item, the electronic device 500 scrolls the transcript in accordance with a speed of movement of the point of contact and without decelerating as described herein and with reference to method 700.

In some embodiments, and as shown in FIG. 6L, when the electronic device 500 decelerates the scrolling to a stop in response to displaying a portion of the transcript corresponding to the current playback position of the content item, the electronic device 500 displays the respective portions of the transcript, such as portions 622bb, 622cc, and 622ce with text having a size larger than the size of the text of the portions 622bb, 622cc, and 622ce when scrolling the transcript, as shown in FIG. 6K. In some embodiments, and as shown in FIG. 6L, the electronic device 500 also displays indications of the speaker (e.g., indications 622aa and 622dd) in FIG. 6L with text having a size larger than the size of the text of the indications of the speaker (e.g., indications 622u, 622w, and 622y) when not scrolling the transcript, as shown in FIG. 6J.

In some embodiments, the electronic device 500 displays the respective portions of the transcript with text having a size smaller than the size of the text of the respective portions of the transcript that is shown in FIG. 6L. For example, in FIG. 6L, the electronic device 500 receives user input 640 (e.g., a swipe contact on a touch-sensitive surface and/or a voice input from the user) corresponding to a request to scroll the transcript in user interface 618a in an upwards direction. In response to receiving the user input 640, the electronic device 500 displays, as shown in FIG. 6M, indications 622dd and 622ff of the speakers of the respective portions of the transcript and portion 622ce with text having a size smaller than the size of the text of the respective portions of the transcript (e.g., portions 622bb, 622cc, and 622ee) when not scrolling the transcript, as shown in FIG. 6L.

As illustrated in FIG. 6M, in response to receiving user input 644 (e.g., a tap input or a contact on a touch-sensitive surface that lasts for less than a threshold period of time (e.g., 0.1, 0.3, 0.5, 0.7, 1, 3, 5, 7, or 10 seconds) followed by a release (e.g., lift-off) of the contact touching the touch sensitive surface) directed to portion 622gg of the transcript of the content item that corresponds to a portion of the content item that the electronic device 500 will play after the portion of the content item the electronic device 500 is currently playing, the electronic device 500 displays a border 642 around portion 622gg that was not displayed prior to receiving user input 644 corresponding to selection of the portion 622gg. While displaying the border 642 around portion 622gg, the electronic device 500 displays the respective portion of the transcript with text having a size larger than the size of the portions of the transcript, such as portion 622cc that is not selected by user input 644, as shown in FIG. 6M. In some embodiments, in response to receiving user input 644 directed to portion 622gg, the electronic device 500 displays portion 622gg having a visual appearance other than having a border. For example, the electronic device 500 optionally displays portion 622gg with a different size, font, color, or other visual appearance as described with reference to method 700 that is different from the visual appearance associated with portion 622gg when portion 622gg is not selected via a user input.

In some embodiments, in response to receiving the user input 644 corresponding to selection of portion 622gg, the electronic device 500 stops playback at the current playback position of the content item and starts playback at the position of the content item corresponding to the respective portion of the transcript as indicated by the tap input, as shown by portion 622hh in FIG. 6N. As shown in FIG. 6N, the electronic device 500 displays portion 622hh corresponding to a portion of the transcript of the content item that the electronic device 500 is currently playing with a visual characteristic (e.g., bolded), different from visual characteristics of portions of the transcript corresponding to portions of the content item the electronic device 500 is not currently playing, such as portions 622gg and 622jj.

In some embodiments, while the electronic device continues to play the content item and display the time-synchronized transcript of the content item, the electronic device 500 provides an operation to search the transcript. For example, in response to receiving user input 692 in FIG. 6N (e.g., similar to user input 644) directed to the user interface 618a that does not include portions of the transcript, indications of the speakers, or other user interface elements (e.g., portions 622hh, 622gg, 622jj; indications 622ff, 622ii; user interface elements 620a or 620b), the electronic device 500 displays the content player user interface element 620cc including the selectable user interface elements (e.g., user interface elements 620c, 620d, 620c, 620f, 618b, 618c, 618d, 618e, and 618f) as described above with reference at least to FIG. 6O. In some embodiments, the electronic device 500 receives user input 692 directed to a location of the user interface 618a that is further than a threshold distance (e.g., 0.5, 1, 2, 4, 6, 8, 10, 15, or 20 centimeters) from one or more of the portions of the transcript, the indications of the speakers, or other user interface elements described herein. In response to the receiving the user input 692 directed to the location of the user interface 618a that is further than the threshold distance from the one or more of the portions of the transcript, the indications of the speakers, or other user interface elements described herein, the electronic device 500 displays the content player user interface element 620cc, as shown in FIG. 6O. The content player user interface element 620cc includes user interface element 618b.

While displaying search user interface element 618b in FIG. 6O, the electronic device 500 receives user input 648 (e.g., a tap input as described above) corresponding to selection of the search user interface element 618b. In response to receiving user input 648 corresponding to selection of the search user interface element 618b, the electronic device 500 displays a soft keyboard user interface element 620g that is interactable to cause the electronic device 500 to receive one or more text entry inputs corresponding to a request to enter search text for performing a search of the transcript. The soft keyboard user interface element 620g also includes a cancel option 620h that, when selected, causes the electronic device to cancel performance of the search operation and/or cease display of the soft keyboard user interface element 620g. As illustrated in FIG. 6P, the electronic device 500 receives text entry inputs via soft keyboard keys 620i corresponding to a request to search for “Cameron Nichols” (e.g., text input 618bb). In some embodiments, the electronic device 500 receives the request to search via user inputs other than text entry input via the soft keyboard keys 620i as described with reference to method 700. For example, the electronic device 500 optionally receives the request to search via a hardware keyboard and/or dictation.

In response to the search request to search for “Cameron Nichols” as shown by text input 618bb in FIG. 6P, the electronic device 500 displays, in FIG. 6Q, one of nine search results as shown by the portion of the transcript that includes “Cameron Nichols” (e.g., portion 622oo). In some embodiments, the electronic device 500 displays the search results while continuing playback of the content item. The electronic device 500 also displays forward and backward options 620j that, when selected, cause the electronic device to navigate through the search results while continuing playback of the content item. For example, in FIG. 6Q, the electronic device 500 receives user input 650 (e.g., a tap input as described above) corresponding to selection of forward option 620j. In response to receiving user input 650, the electronic device 500 displays the next search result as shown in FIG. 6R (e.g., portion 622qq) while continuing playback of the content item. In FIG. 6R, the electronic device 500 receives user input 652 (e.g., a tap input as described above) corresponding to selection of option 620h. In response to receiving user input 652, the electronic device 500 cancels performance of the search operation and/or ceases display of the soft keyboard user interface element 620g, as shown in FIG. 6S.

In some embodiments, the electronic device 500 provides performance of other operations associated with the transcript. For example, in FIG. 6S, the electronic device 500 receives user input 656 (e.g., a tap and hold input or a contact on a touch-sensitive surface that lasts for more than the threshold period of time as described above followed by a release (e.g., lift-off) of the contact touching the touch sensitive surface) directed to portion 622tt of the transcript corresponding to a portion of the content item that will play after the portion of the content item the electronic device 500 is currently playing. In response to the electronic device 500 receiving the user input 656, the electronic device 500 displays a border 654 around portion 622tt that was not displayed prior to receiving user input 656 corresponding to selection of portion 622tt. In some embodiments, the electronic device 500 displays portion 622tt having a visual characteristic other than a border as described with reference to method 700. In some embodiments, portion 622tt includes one or more characteristics as described above with reference to portion 622gg in FIG. 6M.

As illustrated in FIG. 6T, in response to the electronic device 500 receiving the user input 656 in FIG. 6S, the electronic device 500 displays a menu user interface element 660a. The menu user interface element 660a includes selectable options to perform operations associated with the selected portion 622tt of the transcript. For example, menu user interface element 660a includes the following: a play option 660b that, when selected, causes the electronic device 500 to play the content item at a position corresponding to the selected portion of the transcript (e.g., portion 622tt); a share option 660c that, when selected, causes the electronic device 500 to share the selected portion of the transcript including a position of the content item corresponding to the selected portion of the transcript; a copy option 660d that, when selected, causes the electronic device 500 to copy a representation (e.g., text) of the selected portion of the transcript to initiate performance of a copy and paste operation; and a reporting option 660e that, when selected, causes the electronic device 500 to report and/or submit a concern to the source of the transcript as described with reference to method 700.

As illustrated in FIG. 6T, while the electronic device 500 displays the menu user interface element 660a, the electronic device 500 receives user input 658 (e.g., a tap input as described above) corresponding to selection of share option 660c. In response to receiving user input 658, the electronic device 500 initiates an operation to share the selected portion of the transcript including a portion of the content item corresponding to the selected portion of the transcript, such as portion 622tt. In some embodiments, in response to receiving user input 658 as described above, the electronic device 500 initiates an operation to present one or more user interface elements, that when selected, causes the electronic device to share the selected portion of the transcript via one or more forms of communication other than messaging, such as described with reference to method 700. The one or more forms of communication optionally include email, messaging, sharing via an application installed by the electronic device 500, sharing via a hyperlink, or sharing via other wireless communication (e.g., Bluetooth). In some embodiments, the one or more user interface elements presented by the electronic device 500 to initiate an operation to share the selected portion of the transcript includes one or more operations to select one or more users or other electronic devices to share the selection portion of the transcript with. For example, as illustrated in FIG. 6U, the electronic device 500 displays a messaging user interface 662a including a message 662c transmitted from electronic device 500 to a second electronic device, different from the electronic device 500, as represented by user interface element 662b. The message 662c includes a representation of the selected portion of the transcript including the position of the content item corresponding to the selection portion of the transcript. The message 662c also includes a play option 662d that, when selected, causes the electronic device 500 to play the content at the playback position that corresponds to the selected portion of the transcript. For example, in FIG. 6U, the electronic device 500 receives user input 664 (e.g., a tap input as described above) corresponding to selection of the play option 662d. In response to receiving user input 664, the electronic device 500 initiates an operation to play the content item from the position corresponding to the selected portion of the transcript. In some embodiments, in response to receiving user input 664, the electronic device 500 plays at least the selected portion of the transcript while maintaining display of the messaging user interface 662a and/or while displaying a user interface of the content item application, such as user interface 600i in FIG. 6V.

FIG. 6V illustrates user interface 600i that includes content player user interface element 614a and selectable options, such as options 614d through 614l that include one or more of the characteristics of the user interface elements and/or selectable options described with reference to user interface 600i of FIG. 6D. As illustrated in FIG. 6V, while the electronic device 500 displays user interface 600i including menu option 600d, the electronic device 500 receives user input 665 (e.g., a tap input as described above) corresponding to selection of the menu option 600d. In response to receiving user input 665, the electronic device 500 displays menu user interface element 668a, as shown in FIG. 6W.

Menu user interface element 668a includes selectable options that, when selected, cause the electronic device 500 to perform one or more respective actions associated with the content item. For example, the electronic device 500 provides at least one option to view the transcript in a manner that provides the user increased readability as described with reference to method 700. As illustrated in FIG. 6W, the electronic device receives user input 670 (e.g., a tap input as described above) corresponding to selection of the view transcript option 668b. In response to receiving user input 670, the electronic device 500 displays user interface 672a, as shown in FIG. 6X. User interface 672a is a user interface of the podcast application.

FIG. 6X illustrates user interface 672a including user interface element 672b corresponding to the podcast episode description, user interface element 672c that, when selected, causes the electronic device to navigate to parts or particular portions of the transcript as will be described below. The user interface 672a also includes: a search user interface element 672d that, when selected, causes the electronic device 500 to perform a search operation as described above with reference to FIGS. 60-6R; an indication of the provider of the transcript of the content item (e.g., indication 672e), an indication of the speaker of the content item (e.g., indication 672f); a portion of the transcript (e.g., portion 672g); and a content player user interface element 672h that includes one or more of the characteristics of the content player user interface element 604a including the content player user interface element's selectable options described reference to FIG. 6A.

As illustrated in FIG. 6X, the electronic device 500 receives user input 674 (e.g., a tap input as described above) corresponding to selection of the user interface element 672c. In response to receiving user input 674, the electronic device 500 displays content user interface element 676a, as shown in FIG. 6Y. The content user interface element 676a includes a listing of chapters of the transcript (e.g., user interface elements 676a-676e) that, when selected, causes the electronic device 500 to navigate to the respective portion of the transcript corresponding to the selected chapter. For example, in FIG. 6Y, the electronic device 500 receives user input 678 (e.g., a tap input as described above) corresponding to selection of user interface element 676e (e.g., “Chapter 4”). In response to receiving user input 678, the electronic device 500 displays the respective portion of the transcript corresponding to user interface element 676e, as shown in FIG. 6Z. The electronic device 500 also displays an indication of the selected “Chapter 4” as shown by the content of user interface element 672c.

In FIG. 6Z, the electronic device 500 also displays the content player user interface element 672h as described above with reference to FIG. 6X. While displaying the content player user interface element 672h, the electronic device 500 receives user input 672 (e.g., a tap input as described above) corresponding to selection of play option 672i. In response to receiving user input 672, the electronic device 500 plays the content item from the current playback position and displays user interface 676a, as shown in FIG. 6AA. In some embodiments, the electronic device 500 plays the content item and displays user interface 676a independent from the displayed portion of the transcript shown in FIG. 6Z. Alternatively, in response to receiving user input 672, the electronic device 500 starts playing the content item from a position corresponding to the displayed portion of the transcript shown in FIG. 6Z. The user interface 676a includes the transcript of the content item in synchrony with the content item being played as previously discussed below with reference to FIGS. 6F-6N. For example, as shown in FIG. 6AA, portion 680c of the transcript corresponds to a portion of the content item that the electronic device 500 is currently playing and portion 680d corresponds to a portion of the transcript of the content item that will play after the portion of the content item the electronic device 500 is currently playing. As shown in FIG. 6AA, the electronic device 500 displays portion 680c of the transcript that corresponds to the portion of the content item that the electronic device 500 is currently playing with a visual characteristic (e.g., bolded) different from visual characteristics of portions of the transcript corresponding to portions of the content item the electronic device 500 is not currently playing, such as portion 680d. The user interface 676a also includes an indication of a non-transcribable portion (e.g., instrumental music, non-vocals, or dynamic advertisements) of the content item, as illustrated by indication 680a; an indication of the speaker (e.g., indication 680b); user interface element 678a corresponding to the podcast episode description; and a menu user interface element 678b that, when selected, causes the electronic device 500 to perform one or more operations associated with the transcript as described herein and/or with reference to method 700. For example, in FIG. 6AA, the electronic device 500 receives user input 682 (e.g., a tap input as described above) corresponding to selection of menu user interface element 678b. In response to receiving user input 682, the electronic device 500 displays a menu user interface element, such as the menu user interface element 668 in FIG. 6W and in response to a request to view the transcript (as described above with reference to user input 670 directed to option 668b), the electronic device 500 displays the user interface shown in FIG. 6BB.

FIG. 6BB illustrates a user interface that includes characteristics of the user interface 672a described reference to FIG. 6X. The electronic device 500 optionally displays the user interface shown in FIG. 6BB in response to receiving the sequence of inputs described above with reference to FIG. 6AA. For example, in FIG. 6BB, the electronic device 500 displays a portion 684a of the transcript. FIG. 6BB illustrates that portion 684a is selected by the electronic device 500 as indicated by selection marker 684b and 684c that are interactive to cause the electronic device 500 to include more or less text of the portion of the transcript. The electronic device 500 also displays the text selected of portion 684a of the transcript with a color and/or highlighting different from other portions of the transcript (e.g., the portions of the transcript not selected via the selection markers 684b and 684c). As shown in FIG. 6BB, the electronic device 500 displays menu user interface element 686a in response to the selection of text of portion 684a of the transcript. The menu user interface element 686a includes the following selectable options: a copy option 686b that, when selected, causes the electronic device 500 to copy the selected text of portion 684a to initiate performance of a copy and paste operation; a look up option 686c that, when selected, causes the electronic device 500 to initiate an operation to look up a definition or description of the selected text; a share option 686d that, when selected, causes the electronic device 500 to share the text of portion 684a of the transcript including a hyperlink to the transcript of the content item as will be described below; and a play option 686e that, when selected, causes the electronic device 500 to play the content item at a position corresponding to the selected text of portion 684a.

As shown in FIG. 6BB, the electronic device 500 receives user input 688 (e.g., a tap input as described above) corresponding to selection of share option 686d. In response to receiving user input 688, the electronic device 500 displays user interface 690a, as shown in FIG. 6CC. The user interface 690a is a user interface of an email application. In some embodiments, the electronic device 500 shares the text of portion 684a including a hyperlink to the transcript of the content item via an application, different from the email application, such as a messaging application as described above with reference to method FIG. 6U. As illustrated in FIG. 6CC, the user interface 690a of the email application includes an indication of a type of email message (e.g., indication 690b), a recipient of the email message (e.g., recipient 690c), and an option 690f that, when selected, causes the electronic device 500 to transmit the email message to the recipient. In the body of the email message, the electronic device 500 displays the selected text of portion 684a, as shown by user interface element 690d, and a hyperlink 690e that, when selected, causes the electronic device 500 to navigate to the transcript of the content item. In some embodiments, the electronic device 500 navigates to the particular portion of the transcript that includes the selected text (e.g., portion 684a in FIG. 6BB). Although FIGS. 6AA and 6BB illustrate sharing the transcript via email communications, the electronic device 500 presents other user interfaces associated with other forms of communications and is able to share the transcript via the other forms of communication as described above with respect to FIGS. 6T and 6U.

FIG. 7 is a flow diagram illustrating a method in which an electronic device decelerates scrolling a time-synchronized transcript of a content item in accordance with some embodiments. In some embodiments, method 700 is performed at an electronic device (e.g., 500) in communication with one or more input devices and a first display generation component (e.g., 504). For example, the electronic device is a mobile device (e.g., a tablet, a smartphone, a media player, or a wearable device), a computer (e.g., a desktop computer, a laptop computer), or a wearable device (e.g., a watch, a head-mounted device), optionally in communication with one or more of a mouse (e.g., external), trackpad (optionally integrated or external), remote control device (e.g., external), another mobile device (e.g., separate from the first electronic device), a handheld device (e.g., external), and/or a controller (e.g., external), or a set-top box in communication with one or more input devices (e.g., a remote control). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users. In some embodiments, the one or more input devices include a computer system or component capable of receiving a user input (e.g., capturing a user input and/or detecting a user input) and transmitting information associated with the user input to the electronic device. Examples of input devices include physical buttons, knobs, handles, and/or switches of the electronic device, a touch screen, mouse (e.g., external), trackpad (optionally integrated or external), touchpad (optionally integrated or external), microphone for capturing voice commands or other audio input, remote control device (e.g., external), another electronic device (e.g., mobile device that is separate from the electronic device), a handheld device (e.g., external), a controller (e.g., external), a camera, a depth sensor, an eye tracking device, and/or a motion sensor (e.g., a hand tracking device, a hand motion sensor).

In some embodiments, while playing a content item, such as user interface element 620a in FIG. 6I, the electronic device displays (e.g., 702a), via the display generation component, a content user interface including a first portion of a transcript of the content item, such as portion 6220 in FIG. 6I. In some embodiments, the content item is podcast content (e.g., spoken word), audio content (e.g., music, sung/spoken word, or audio book), and/or video content. In some embodiments, the content user interface is a user interface of a media application in which the content item can be played, such as a podcast application, a music application, an electronic book application, or other media content application. In some embodiments, the transcript of the content item includes a collection of textual representations corresponding to transcribable components (e.g., vocals, such as spoken or sung words) and non-transcribable components (e.g., instrumental music, non-vocals, or dynamic advertisements) of the content item. Dynamic advertisements optionally include varied content selected or inserted dynamically into the content item and optionally includes a variable number of advertisements with positions in the content item that optionally changes. In some embodiments, the transcript is automatically generated by the electronic device. In some embodiments, the transcript is generated by an entity other than the electronic device, such as content providers, companies, networks, or organizations known for the production and distribution of transcripts. In some embodiments, the electronic device retrieves the transcript from a local database maintained by the electronic device or from a remote server/database in communication with the electronic device. In some embodiments, and as will be described below, displaying the content user interface including the transcript includes displaying a source of the transcript. In some embodiments, the electronic device displays the transcript in synchrony with the content item being played. For example, the electronic device optionally displays the first portion of the transcript (e.g., textual representations by word(s) or by line(s)) synchronized to the timing of the transcribable components (e.g., words spoken by the speakers) of the content item, much like the display of lyrics in karaoke. In some embodiments, the electronic device displays the first portion of the transcript in advance of the words being spoken by the speakers of the content item. In this way, the electronic device optionally displays portions of the transcript before playback of the content item begins as a preview of the transcribable components. In some embodiments, the electronic device displays words that have already been spoken. In some embodiments, the electronic device displays transcribable components different from the non-transcribable components as will be described in more detail below. In some embodiments, the electronic device displays one or more textual representations of the transcript at a time (e.g., that correspond to a current playback position of the content item) when the corresponding transcribable components are being spoken. In some embodiments, the electronic device displays one or more textual representations of the transcript in a scrolling manner so that portions of the transcript are displayed at a time that the corresponding portion of content item is being played. In some embodiments, the electronic device visually emphasizes (e.g., highlights) the one or more textual representations relative to other textual representations of the transcript when the transcribable components are being spoken. In some embodiments, one or more portions of the content item corresponding to the other textual representations of the transcript have yet to be spoken/output (e.g., that correspond to a playback position of the content item other than the current playback position of the content item). In some embodiments, visually emphasizing the one or more textual representations includes using a different sizes, colors, transparency levels, opacity, highlighting, lighting, shadow and/or another display property. In this regard, the transcript has a dynamic, animated appearance where the textual representations are visually emphasized at times when the corresponding transcribable components are being spoken (e.g., in synchrony). Additionally or alternatively, in some embodiments, the electronic device scrolls the transcript in a time-synchronized manner relative to playback of the content item. For example, the electronic device displays a portion of the transcript corresponding to the currently playing portion of the content item in a predefined region of the user interface, such as at the top of a portion of the transcript the electronic device is currently displaying. In some embodiments, the electronic device provides a mechanism for a user of the electronic device to scroll forwards or backwards in the transcript in accordance with a scrolling input without changing the playback position of the content item in accordance with scrolling the transcript. In some embodiments and as will be described in more detail below, the electronic device displays the transcript in a manner that is different than the manner in which the transcript is displayed while scrolling. For example, the electronic device optionally displays the one or more textual representations of the time-synchronized transcript in a size larger than a size of the one or more textual representations of the time-synchronized transcript whilst scrolling through the transcript in response to or while detecting the scrolling input. In some embodiments and as will be described herein, the electronic device decelerates scrolling when scrolling past a portion of the transcript corresponding to the current playback position of the content item (e.g., the textual representations of the transcript associated with the transcribable components and/or non-transcribable components being spoken/output).

In some embodiments, while playing the content item and displaying the content user interface including the first portion of the transcript of the content item, the electronic device receives (e.g., 702b), via the one or more input devices, a scrolling input, such as user input 630 in FIG. 6I. In some embodiments, the scrolling input corresponds to a request to scroll the transcript and/or the content user interface in response to detecting an upward or downward swipe of a contact on a touch-sensitive surface (e.g., display generation component of the electronic device or a touch-sensitive surface of a second electronic device, such as a remote control device in communication with the electronic device) or an air pinch and drag gesture that is detected via the electronic device when the electronic device corresponds to a head-mounted device. In some embodiments, the electronic device detects a speed (e.g., magnitude), velocity (e.g. magnitude and direction), acceleration (e.g., magnitude and/or direction), duration, distance, and/or direction of the scrolling input corresponding to scrolling the transcript and/or the content user interface.

In some embodiments, in response to receiving the scrolling input (e.g., 702c), the electronic device scrolls (e.g., 702d) the transcript in accordance with the scrolling input (e.g., speed of movement of the point of contact with the display generation component), such as indicated by scrolling speed indicator 636 in FIG. 6I, including: in accordance with a determination that a currently displayed portion of the transcript includes a second portion of the transcript that corresponds to a current playback position of the content item, such as portion 622cc in FIG. 6K, the electronic device scrolls (e.g., 702e) the second portion of the transcript based on a first deceleration profile that includes decelerating by a first amount while displaying the second portion of the transcript that corresponds to the current playback position of the content item, such as indicated by the scrolling speed indicator 638 in FIG. 6K. In some embodiments, the currently displayed portion of the transcript includes a new portion (e.g., second portion) of the transcript that is in view in a viewing area of the display generation component. In some embodiments, when the scrolling input corresponds to an upwards direction, the new portion of the transcript appears at the bottom of the viewing area and other portions of the transcript are moved up. In some embodiments, portions of the transcript located at the top of the viewing area are moved outside the viewing area in response to receiving the upwards scrolling input. Similarly, when the scrolling input corresponds to a downwards direction, the new portion of the transcript optionally appears at the top of the viewing area and other portions of the transcript are moved down. In some embodiments, in response to receiving the downwards scrolling input, portions of the transcript located at the bottom of the viewing area are moved outside the viewing area. In some embodiments, the electronic device accelerates scrolling through portions of the transcript in response to an accelerated movement of the scrolling input (e.g., moving the point of contact at greater speeds). For example, the accelerated movement of the scrolling input optionally includes an accelerated movement of the point of contact followed by decelerating with simulated inertia in response to detecting a break in the scrolling input (e.g., a break of the point of contact, liftoff the point of contact, or ceasing of motion of the input). Accordingly, the electronic device optionally stops scrolling through portions of the transcript in response to detecting the break in the scrolling input that is followed by a (stationary) point of contact with the display generation component. In some embodiments, if the stationary point of contact is not detected by the electronic device, the electronic device continues scrolling slowly through the transcript to a point at which the scrolling comes to a stop. In some embodiments and as will be described in more detail below, when the electronic device decelerates scrolling through portions of the transcript in response to the scrolling input, the electronic device skips display of one or more portions of the transcript. In some embodiments, in accordance with a determination that a currently displayed portion of the transcript includes a second portion of the transcript that corresponds to a current playback position of the content item, the scrolling motion and/or acceleration of the scrolling is based on a first deceleration profile that includes decelerating by a first amount (e.g., having a dampened acceleration of the scrolling) while displaying the second portion of the transcription that corresponds to the current playback position of the content item. Decelerating by the first amount is optionally dampening the scrolling motion and/or acceleration of the scrolling to an amount less than an amount associated with the scrolling motion and/or acceleration of the scrolling prior to displaying the second portion of the transcription that corresponds to the current playback position of the content item. For example, the electronic device slows down scrolling the transcript while scrolling the second portion of the transcript corresponding to the portion of the content item the electronic device is currently playing. In this regard, while scrolling the transcript and in accordance with a determination that the scrolling includes displaying the second portion of the transcript that corresponds to the current playback position of the content item, the displayed transcript including the second portion of the transcript optionally appears to have “snapped to” or “bounced off” a beginning of the textual representations corresponding to the second portion of the transcript. In some embodiments, the apparent “snapping” or “bounce” includes a simulated effect in which an object having momentum strikes a wall (e.g., textual representations corresponding to the second portion of the transcript that corresponds to the current playback position of the content item) such that further motion decelerates the object to a stop. In some embodiments, decelerating includes decelerating to a stop or dampened motion at which to “snap” to the second portion of the transcript that corresponds to the current playback position of the content item (e.g., scroll to a respective location of the transcript corresponding to the second portion of the transcript) without detecting input for scrolling to the particular location corresponding the second portion of the transcript that corresponds to the current playback position of the content item. In some embodiments, the direction of scrolling is reversed in response to a determination that scrolling the transcript includes displaying the second portion of the transcript that corresponds to the current playback position of the content item. For example, the direction of scrolling optionally reverses momentarily and “snaps” to the second portion of the transcript.

In some embodiments, in accordance with a determination that the currently displayed portion of the transcript is a third portion of the transcript, such as portion 622V in FIG. 6J, different from the second portion of the transcript (and while not displaying the second portion of the transcript), that does not correspond to the current playback position of the content item, the electronic device scrolls (e.g., 702f) the third portion of the transcript in a manner that is not based on the first deceleration profile (e.g., based on a second deceleration profile, different from the first deceleration profile, such as indicated by scrolling input 630 in FIG. 6I and resulting scrolling speed indicator 636 in FIG. 6J) that does not include decelerating by the first amount while displaying the third portion of the transcript, such as described above with reference to 702e in FIG. 7. In some embodiments, the third portion of the transcript corresponds to a particular playback position of the content item that is after the current playback position or before the current playback position. In some embodiments, the third portion of the transcript is associated with textual representations of the transcript that have yet to be spoken or textual representations of the transcript that have already been spoken. In some embodiments, scrolling the transcript based on a second deceleration profile includes scrolling in accordance with a speed of movement of the point of contact and without decelerating by the first amount as described herein. In some embodiments, scrolling the transcript based on a second deceleration profile is accelerated in response to an accelerated movement of the scrolling input (e.g., point of contact). In some embodiments, scrolling through the transcript in response to a scrolling input optionally includes scrolling through a respective portion of the transcript and if the respective portion of the transcript corresponds to the current playback position of the content item, the electronic device scrolls the respective portion of the transcript based on the first deceleration profile. In some embodiments, if the respective portion does not correspond to the current playback position of the content item, the electronic device scrolls the respective portion of the transcript based on a deceleration profile other than the first deceleration profile (e.g., in a manner that is not based on the first deceleration profile), such as the second deceleration profile as discussed herein. In some embodiments, scrolling the transcript does not change the playback position of the content item. Scrolling a transcript based on a deceleration profile that includes decelerating by an amount while displaying a portion of the transcript that corresponds to a current playback position of a content item in response to a determination that that scrolling the transcript includes displaying the second portion of the transcript that corresponds to the current playback position of the content item provides a quick and efficient way of aligning display of the transcript to the current playback position without requiring the user to provide further inputs to precisely locate the portion of the transcript that corresponds to the current playback position, thereby reducing errors in interacting with user interfaces, which provides a more efficient user-electronic device interface, reduces power consumption, and improves battery life of the electronic device.

In some embodiments, while scrolling the transcript in accordance with the scrolling input, and before detecting an end of the scrolling input, such as scrolling input 624 in FIG. 6G, (e.g., before detecting a break of the point of contact, liftoff the point of contact, or ceasing of motion of the scrolling input), in accordance with a determination that the currently displayed portion of the transcript is a fourth portion of the transcript that corresponds to the current playback position of the content item, such as portion 622h in FIG. 6G, (optionally the same as the second portion of the transcript), the electronic device scrolls the fourth portion of the transcript in a manner based on movement of the scrolling input that is not based on the first deceleration profile (e.g., based on the location of the point of contact, such as the location of scrolling input 624 in FIG. 6G) that does not include decelerating by the first amount while displaying the fourth portion of the transcript that corresponds to the current playback position of the content item as described with reference to 702e in FIG. 7. In some embodiments, the fourth portion of the transcript that corresponds to the current playback position of the content item is different from the second portion of the transcript that corresponds to the current playback position of the content item. In some embodiments, the fourth portion of the transcript is the same as the second portion of the transcript. In some embodiments, the fourth portion includes one or more characteristics of the second portion described above. In some embodiments, scrolling the fourth portion of the transcript in the manner based on movement of the scrolling input that is not based on the first deceleration profile includes scrolling in accordance with a speed of movement of the point of contact and without decelerating by the first amount as described above. For example, scrolling the fourth portion of the transcript in a manner based on movement of the scrolling input optionally includes the electronic device scrolling the fourth portion of the transcript at a speed of movement of the point of contact until the electronic device detects the end of the scrolling input. For example, the electronic device optionally scrolls the fourth portion of the transcript at substantially a same (or matching) speed of the scrolling input if the electronic device does not detect the end of the scrolling input. In some embodiments, when the electronic device detects the end of the scrolling input, the electronic device stops scrolling the fourth portion of the transcript in response to detecting the end of the scrolling input. In some embodiments, the electronic device continues scrolling slowly through the fourth portion of the transcript to a point at which the scrolling comes to a stop in response to detecting the end of the scrolling input, such as, for example, a swipe of the contact including liftoff the point of contact. In some embodiments, a direction, distance, velocity, and/or acceleration of scrolling the fourth portion of the transcript corresponds to a direction, distance, velocity, and/or acceleration of the scrolling input/contact.

In some embodiments, in accordance with a determination that the currently displayed portion of the transcript is a fifth portion of the transcript, different from the fourth portion of the transcript, that does not correspond to the current playback position of the content item, such as portion 622k in FIG. 6H, (e.g., and while not displaying a portion of the transcript corresponding to the current playback position), the electronic device scrolls the fifth portion of the transcript in the manner based on the movement of the scrolling input that is not based on the first deceleration profile (e.g., based on the second deceleration profile described above and as indicated by scrolling speed indicator 632 in FIG. 6I) that does not include decelerating by the first amount while displaying the fifth portion of the transcript, such as described with reference to method 702e in FIG. 7. In some embodiments, the fifth portion of the transcript that does not correspond to the current playback position of the content item is different from the third portion of the transcript that does not correspond to the current playback position of the content item. In some embodiments, the fifth portion includes one or more characteristics of the third portion described above. In some embodiments, scrolling the fifth portion of the transcript based on the second deceleration profile includes scrolling in accordance with a speed of movement of the point of contact and without decelerating by the first amount while displaying the fifth portion of the transcript as described above. In some embodiments, a direction, distance, velocity, and/or acceleration of scrolling the fifth portion of the transcript corresponds to a direction, distance, velocity, and/or acceleration of the scrolling input/contact. Scrolling a transcript based on the movement of the scrolling input that is not based on the first deceleration profile while detecting the scrolling input, and before detecting an end of the scrolling input provides a quick and efficient way of displaying the transcript continuously without requiring the user to provide further inputs to navigate forwards or backwards via user interface objects (e.g., “back” or “next” buttons), thereby reducing interruptions associated with loading a particular portion of the transcript and reducing errors in interacting with user interfaces, which provides a more efficient user-electronic device interface, reduces power consumption, and improves battery life of the electronic device.

In some embodiments, in accordance with a determination that the scrolling input will cause the currently displayed portion of the transcript to include the second portion of the transcript during the scrolling in response to the scrolling input, such as portion 622hh in FIG. 6N, the electronic device forgoes display of one or more portions of the transcript, such as indications 622ff and 622ii in FIG. 6N, before displaying the second portion of the transcript during the scrolling in response to the scrolling input. In some embodiments, the one or more portions of the transcript that are not displayed before displaying the second portion of the transcript during the scrolling in response to the scrolling input include content other than words that are spoken, sung, etc. in the content item, such as titles, numbers and/or descriptions of content item chapters or segments, and/or indications of the speaker(s) of the content item.

In some embodiments, in accordance with a determination that the scrolling input will not cause the currently displayed portion of the transcript to include the second portion of the transcript during the scrolling in response to the scrolling input, the electronic device displays the one or more portions of the transcript during the scrolling in response to the scrolling input, such as displaying indications 622u, 622w, and 622y in FIG. 6J. In some embodiments, scrolling the transcript does not include forgoing display of the one or more portions of the transcript. For example, scrolling the transcript optionally includes displaying the one or more portions of the transcript. Foregoing display of one or more portions of the transcript when scrolling the transcript provides a quick and efficient way of traversing the transcript, thereby reducing the need for subsequent inputs to locate a desired portion of the transcript in a potentially large transcript which reduces power usage and improves battery life of the electronic device by enabling the user to use the electronic device more quickly and efficiently (e.g., the user does not need to scroll through portions of the transcript and can instead skip portions of the transcript so that a desired portion of the transcript is located and displayed quickly), which provides a more efficient user-electronic device interface, reduces power consumption, and improves battery life of the electronic device.

In some embodiments, while playing the content item and while not scrolling the transcript in response to receiving the scrolling input (or any other scrolling input) and while displaying the content user interface including the first portion of the transcript of the content item, the electronic device displays, via the display generation component, the first portion of the transcript with text having a first size, such as shown by portions 622bb, 622cc, and 622ce of the transcript in FIG. 6L. For example, the text of the first portion of the transcript is optionally displayed with a first size (e.g., first length, width, depth, and/or thickness), first brightness (e.g., first degree of illumination, gloss, highlight, and/or shadow), first color (e.g., degree of focus, opacity, and/or animation), and/or first font (e.g., bolded, underlined, and/or italicized).

In some embodiments, while scrolling the transcript in accordance with the scrolling input and displaying a respective portion of the transcript, the electronic device displays, via the display generation component, the respective portion of the transcript with text having a second size, less than the first size, such as shown by portion 622ee of the transcript in FIG. 6M. In some embodiments, the electronic device displays the respective portion of the transcript with text having a second brightness, less than the first brightness; a second color, different from the first color; and/or a second font, different from the first font of the text corresponding to the first portion of the transcript. In some embodiments, the respective portion of the transcript that is displayed in the viewing area of the display generation component is larger than the first portion (because the respective portion of the transcript with text has the second size). In some embodiments, when the electronic device detects an end of the scrolling input as described above, the electronic device displays the respective portion of the transcript with text having the first size as described herein. In some embodiments, when the electronic device stops scrolling the transcript in response to detecting the end of the scrolling input, the electronic device displays the respective portion of the transcript with text having the first size as described herein. For example, the electronic device optionally transitions from displaying the text of the respective portion of the transcript with the second size to displaying the text of the respective portion of the transcript with first size. In some embodiments, while scrolling the transcript in accordance with the scrolling input and displaying the respective portion of the transcript, the electronic device displays, via the display generation component, the respective portion of the transcript with text having the first size or a size greater than the first size. For example, the electronic device optionally displays the respective portion of the transcript with text having a predetermined size irrespective of whether the electronic device is scrolling the transcript in accordance with the scrolling input. In some embodiments, displaying the respective portion of the transcript with text having the second size, less than the first size, includes displaying a larger portion (e.g., more content) of the transcript than the electronic device displaying the transcript having the first size. Displaying the respective portion of the transcript with text having a smaller size while scrolling provides a quick and efficient way of displaying the transcripts, thereby reducing the need for subsequent inputs to locate a desired portion of the transcript in a potentially large transcript which reduces power usage and improves battery life of the electronic device by enabling the user to use the electronic device more quickly and efficiently (e.g., the user does not need to scroll through portions of the transcript and can instead view larger portions of the transcript because the text is displayed with a smaller size so that a desired portion of the transcript is located and displayed quickly), which provides a more efficient user-electronic device interface, reduces power consumption, and improves battery life of the electronic device.

In some embodiments, in accordance with a determination that the first portion of the transcript includes transcribable content or audio, the electronic device displays, via the display generation component, a transcription of the first portion of the transcript, such as portions 622h, 622i, 622k, and 622m in FIG. 6G. For example, the transcription of the first portion of the transcript optionally includes text, words, and/or glyphs. In some embodiments, the transcription of the first portion of the transcript corresponds to the audio content of the first portion of the transcript.

In some embodiments, in accordance with a determination that the first portion of the transcript does not include transcribable content or audio, the electronic device forgoes displaying, via the display generation component, the transcription of the first portion of the transcript, such as for example, the electronic device displays indication 622f of non-transcribable content in FIG. 6G. For example, the transcription of the first portion of the transcript corresponding to non-transcribable content or audio optionally includes ellipses or other characters/content (e.g., “Advertisement,” “Music,” “Non-transcribable content”) indicating that the first portion of the transcript does not include transcribable content or audio (e.g., the first portion of the transcript is not transcribable into text). In some embodiments, non-transcribable content or audio includes dynamic advertisements, instrumental music, non-vocals, and/or the like. It is understood that although the embodiments described herein are directed to the first portion of the transcript, such functions and/or characteristics, optionally apply to other portions of the transcript including the second portion of the transcript. Displaying a representation of a portion of transcript that does not include transcribable content provides feedback that the portion of the transcript is non-transcribable, which avoids interruption in displaying the transcript and provides a more efficient user-electronic device interface.

In some embodiments, wherein displaying the content user interface including the first portion of the transcript of the content item includes displaying a visual indication of a source of the transcript, such as indication 600k in FIG. 6E. For example, the visual indication of the source of the transcript optionally includes text, images, and/or media content identifying and/or describing the source of the transcript. In some embodiments, the source of the transcript is a third-party entity in communication with the electronic device. In some embodiments, the source of the transcript in an entity that produced the content item. In some embodiments, the source of the transcript is an application operating on the electronic device. In some embodiments, the electronic device transcribes the content item in real-time as the content item is being played. In some embodiments, the content item is transcribed by a human or a machine (e.g., automated transcription). In some embodiments, the content user interface includes a user interface that, when selected, causes the electronic device to report and/or submit a concern to the source of the transcript. In some embodiments, the electronic device displays the visual indication of the source of the transcript at the end of the transcript, the beginning of the transcript, or in a location within the transcript other than the end or the beginning of the transcript. Providing a visual indication of the source of the transcript provides a quick way of indicating to the user the transcript is provided by third parties and/or applications in communication with the electronic device, without requiring the user to provide further inputs to navigate away from the user interface to identify the source of the transcript, thereby reducing the number of inputs and providing more efficient interactions between the user and the electronic device.

In some embodiments, displaying the first portion of the transcript with a visual characteristic (e.g., size, brightness, color, and/or font style) having a first value and in accordance with a determination that the first portion of the transcript is associated with (e.g., includes) a name of a speaker, the electronic device displays, via the display generation component, a representation of the name of the speaker with a visual characteristic having a second value, different from the first value, such as indication 622g having a font style different from the font style associated with portion 622h and 622i in FIG. 6G. For example, a first value for the visual characteristic “size” optionally includes for example, a first length, a first width, a first depth, and/or a first thickness; a first value for the visual characteristic “brightness” includes for example, a first degree of illumination, a first degree of gloss, a first degree of highlight, and/or a first shadow; a first value for the visual characteristic “color” includes for example, a first degree of focus, a first degree of opacity, a first hue, a first degree of saturation, and/or a first animation; a first value for the visual characteristic “font style” includes for example a first degree of bolding, a first degree of underlining, and/or a first degree of italicizing. In some embodiments, the representation of the name of the speaker with the visual characteristic having the second value is displayed with a greater size (e.g., increased length, increased width, greater thickness, and/or greater depth); a higher degree of brightness (e.g., darker shadow, higher illumination, a greater gloss and/or a greater highlight); a greater color intensity (e.g., more colored to convey depth, a greater opacity, a greater focus, and/or greater animation; and/or a more intense font style (e.g., more intense bolding, more intense underlining, and/or more intense italicizing) relative to the first portion of the transcript.

In some embodiments, in accordance with a determination that the first portion of the transcript is not associated with a the name of a speaker, the electronic device foregoes displaying, via the display generation component, the representation of the name of the speaker, such as foregoing displaying indication 622l of FIG. 6G. Displaying a representation of the name of the speaker with an emphasized visual characteristic provides a quick way of indicating to the user the name of the speaker, thereby ensuring visibility of the name of the speaker which provides a more efficient user-electronic device interface, reduces power consumption, and improves battery life of the electronic device.

In some embodiments, while scrolling the transcript in accordance with the scrolling input, the electronic device displays, via the display generation component, the first portion of the transcript with a visual characteristic (e.g., size, brightness, color, and/or font style) having a first value, such as portion 622ee having a first text size in FIG. 6M. In some embodiments, the first portion of the transcript with a visual characteristic having a first value includes one or more characteristics of the respective portion of the transcript with text having the second size as described above. For example, the first portion of the transcript with the visual characteristic having the first value is optionally displayed with a smaller size (e.g., decreased length, decreased width, less thickness, and/or less depth) while scrolling the transcript. In contrast, while not scrolling the transcript, the electronic device displays the first portion of the transcript with a larger size (e.g., increased length, increased width, greater thickness, and/or greater depth).

In some embodiments, while scrolling the transcript in accordance with the scrolling input and displaying a respective portion of the transcript with the visual characteristic having the first value, the electronic device receives, via the one or more input devices, a tap input directed to a fourth portion of the transcript, such as input 644 in FIG. 6M. In some embodiments, the tap input is a touch on a touch sensitive surface that lasts for less than a threshold period of time (e.g., 0.1, 0.3, 0.5, 0.7, 1, 3, 5, 7, or 10 seconds) followed by a release (e.g., lift-off) of the contract touching the touch sensitive surface.

In some embodiments, in response to receiving the tap input, the electronic device displays, via the display generation component, the fourth portion of the transcript with the visual characteristic having a second value, different from the first value, such as portion 622hh having a second text size, larger than the first text size, and a font style different from the font style associated with portion 622ce in FIG. 6M. For example, in some embodiments, the fourth portion of the transcript with the visual characteristic having the second value is displayed with a greater size (e.g., increased length, increased width, greater thickness, and/or greater depth) than displaying the transcript with the visual characteristic having the first value. In some embodiments, the electronic device stops scrolling the transcript in response to receiving the tap input. In some embodiments, additionally or alternatively to the electronic device displaying the fourth portion of the transcript with the visual characteristic having the second value in response to receiving the tap input, the electronic device snaps to (e.g., displays and/or scrolls to) the fourth portion of the transcript that corresponds to the current playback position of the content item. In some embodiments, the electronic device snaps to the fourth portion of the transcript without changing the playback position of the content to corresponds to the fourth portion of the transcript. In some embodiments, additionally or alternatively to the electronic device displaying the respective portion of the transcript with the visual characteristic having the second value in response to receiving the tap input, the electronic device plays the content item from a respective position corresponding to the respective portion of the transcript as indicated by the tap input. For example, the electronic device optionally stops playback at the current playback position of the content item and starts playback at the position of the content item corresponding to the respective portion of the transcript as indicated by the tap input. It is understood that although the embodiments described herein include a tap input, any number of user inputs are optionally applied, such as a click input, (e.g., via a mouse, trackpad, or another computer system in communication with the electronic device), actuation of a physical input device, a predefined gesture (e.g., pinch gesture or air tap gesture) and/or a voice input from the user) corresponding to (optionally selection of) the respective portion of the transcript. In some embodiments, in response to determining that scrolling the transcript includes displaying the portion of the transcript that corresponds to the current playback position of the content item, the electronic device displays the portion of the transcript that corresponds to the current playback position with the visual characteristic having the first value as described herein. For example, the portion of the transcript that corresponds to the current playback position with the visual characteristic having the first value is optionally displayed with a less highlight while scrolling the transcript. In contrast, while not scrolling the transcript, the electronic device displays the portion of the transcript that corresponds to the current playback position with greater highlight. Displaying the respective portion of the transcript with text having a larger size in response to a tap input provides a quick way of indicating to the user the electronic device is responsive to the tap input, which provides a more efficient user-electronic device interface, reduces power consumption, and improves battery life of the electronic device.

In some embodiments, while displaying the content user interface including the first portion of the transcript of the content item, the electronic device receives, via the one or more input devices, a tap input that corresponds to selection of the first portion of the transcript, such as input 656 in FIG. 6S. In some embodiments, the tap input that corresponds to selection of the first portion of the transcript is a touch and hold on a touch sensitive surface that lasts for longer than the threshold period of time as described above. It is understood that although the embodiments described herein with reference to method 800 include or refer to a tap input, such as touch input, the tap input (or any user input described herein and throughout) optionally corresponds to any selection input, whether or not including a physical touch of an object on a touch-sensitive surface, including a gaze-based input, an activation-based input such as contact on the touch-sensitive surface as described herein, a tap input as described herein, or a click input, (e.g., via a mouse, trackpad, or another computer system in communication with the electronic device), actuation of a physical input device, a predefined gesture (e.g., pinch gesture or air tap gesture, such as a gesture performed by a hand of a user without contacting any surface) and/or a voice input from the user) corresponding to (optionally selection of) the first portion of the transcript.

In some embodiments, in response to receiving the tap input, in accordance with the tap input satisfying one or more criteria, displaying, via the display generation component, one or more selectable options, such as options 660b-660e in FIG. 6T, that, when selected, cause the electronic device to perform one or more actions associated with the first portion of the transcript, such as a sharing action illustrated in FIGS. 6T and 6U. In some embodiments, the one or more criteria include a criterion that is satisfied when the electronic device receives the tap input that includes a touch and hold on a touch sensitive surface that lasts for longer than the threshold period of time as described above. It is understood that although the embodiments described herein include a tap input, any number of user inputs are optionally applied, such as described above and corresponding to selection of the first portion of the transcript. In some embodiments, the one or more selectable options are presented via a menu user interface element displayed concurrently with or overlaid the content user interface. In some embodiments, displaying the menu user interface element does not include obscuring the first portion of the transcript. In some embodiments, the electronic device displays the first portion of the transcript as visually emphasized (e.g., with a visual characteristic having a first value, a second value, or other value as described above) relative to other portions of the transcript (e.g., portions of the transcript other than the first portion that is selected). In some embodiments, additionally and/or alternatively to the electronic device displaying the first portion of the transcript as visually emphasized, the electronic device displays graphics, such as a container including a visible or invisible border around the first portion of the transcript that was not displayed prior to receiving the tap input corresponding to selection of the first portion of the transcript. For example, the first portion of the transcript that was selected is optionally displayed with a greater highlight, larger text, and/or within a container in response to selection via the tap input. In contrast, other portions of the transcript not selected are optionally displayed without highlighting, smaller text, and/or not within a container. In some embodiments, the one or more selectable options include a play option that, when selected, causes the electronic device to play the content item at a position corresponding to the first portion of the transcript. In some embodiments, the one or more selectable options include a share option that, when selected, causes the electronic device to share a portion of the content including a position of the content item corresponding to the first portion of the transcript. In some embodiments, the one or more selectable options include a copy option that, when selected, causes the electronic device to copy a representation (e.g., text) of the first portion of the transcript to initiate performance of a copy and paste operation. In some embodiments, the one or more selectable options include a reporting option that, when selected, causes the electronic device to report and/or submit a concern to the source of the transcript as described above. Providing selectable options that, when selected, cause the electronic device to perform one or more actions associated with the first portion of the transcript provides a quick way of performing the one or more actions, without requiring the user to provide further inputs to navigate away from the user interface to perform the one or more actions, thereby reducing the number of inputs and providing more efficient interactions between the user and the electronic device.

In some embodiments, the content user interface includes an indication of metadata associated with a first part of the content item, such as user interface element 672c in FIG. 6X, (e.g., text, title, numbers and/or description of content item chapters or segments). In some embodiments, when the content item is a podcast series or collection, the first part of the content item corresponds to a first episode of the podcast series. In some embodiments, the content user interface includes indications of metadata, such as, for example, if the content item is a podcast, metadata optionally includes episode information, season information, release date/time, duration, category, speaker, title, description, language(s) spoken, parental advisory information, trigger warnings, author, owner, and/or other podcast information. In another example, if the content item is an audiobook, metadata optionally includes the same metadata as a podcast including the narrator, publisher, genre, and/or other audiobook information. In some embodiments, the electronic device displays the indication of metadata associated with the first part of the content item as visually emphasized (e.g., with a visual characteristic having a first value, a second value, or other value as described above) relative to other portions of the transcript (e.g., portions of the transcript that do not include metadata). It is understood that the content user interface optionally includes a plurality of indications of metadata of different types and displayed with a same portion or different portions of the transcript of the content item. Displaying an indication of metadata associated with a first part of the content item provides a quick way of indicating to the user the metadata information, without requiring the user to provide further inputs to navigate away from the user interface to identify metadata information of the content item, thereby reducing the number of inputs and providing more efficient interactions between the user and the electronic device.

In some embodiments, while displaying the content user interface including the indication of the first part of the content item (e.g., first chapter, segment, section, and/or other division of the content item), such as user interface element 672c in FIG. 6Y, the electronic device receives, via the one or more input devices, a tap input that corresponds to selection of the indication of the first part of the content item, such as input 678 in FIG. 6Y. In some embodiments, the tap input is a touch on a touch sensitive surface directed to the indication of the first part of the content item that lasts for less than a threshold period of time as described above followed by a release (e.g., lift-off) of the contract touching the touch sensitive surface. It is understood that although the embodiments described herein include a tap input, any number of user inputs are optionally applied, such as described above and corresponding to selection of the indication of the first part of the content item.

In some embodiments, in response to receiving the tap input, the electronic device displays, via the display generation component, a user interface element, such as user interface element 676e in FIG. 6Y, that, when selected, causes the electronic device to navigate to a second part of the content item, different from the first part of the content item, such as shown by user interface element 672c in FIG. 6Z. For example, the user interface element optionally includes a menu of parts of the content item (e.g., first chapter, second chapter, and third chapter) that, when selected, causes the electronic device to navigate (e.g., display) to the particular part of the content item corresponding to the selected part. In some embodiments, navigating to the second part of the content item, different from the first part of the content item, includes displaying the respective portion of the transcript that corresponds to the second part of the content item. In some embodiments, navigating to the second part of the content item, different from the first part of the content item includes playing the content item from a position corresponding to the second part of the content item. In some embodiments, the content user interface includes the indication of the first part of the content item and a second indication of a third part of the content item that, when selected, causes the electronic device to navigate to a third part of the content item, different from the second part of the content item. Providing a user interface element that, when selected, causes the electronic device to navigate to a particular part of the content item provides a quick way of navigating to the particular part of the content item, without requiring the user to provide further inputs to scroll and traverse through the content item to get to the desired part of the content item, thereby reducing the number of inputs and providing more efficient interactions between the user and the electronic device.

In some embodiments, the content user interface includes a first user interface element, such as user interface element 618b in FIG. 6O. In some embodiments, the first user interface element is a searching user interface element that, when selected, causes the electronic device to perform a search operation as described herein. For example, the first user interface element optionally includes a text entry field.

In some embodiments, while displaying the content user interface including the first user interface element, the electronic device receives, via the one or more input devices, a tap input that corresponds to selection of the first user interface element, such as input 648 in FIG. 6O. In some embodiments, the tap input is a touch on a touch sensitive surface directed to the indication of the first user interface element that lasts for less than a threshold period of time as described above followed by a release (e.g., lift-off) of the contract touching the touch sensitive surface. It is understood that although the embodiments described herein include a tap input, any number of user inputs are optionally applied, such as described above and corresponding to (optionally selection of) the first user interface element.

In some embodiments, in response to receiving the tap input, the electronic device displays, via the display generation component, a second user interface element associated with a search operation associated with searching the transcript, such as user interface element 620g in

FIG. 6P. For example, the second user interface element associated with a search operation optionally includes a soft keyboard, a text entry field, and/or a selectable option that, when selected, causes the computer system to search the transcript for content entered into the text entry field. In some embodiments, the second user interface element is displayed concurrently with or overlaid the transcript. In some embodiments, the second user interface element (e.g., the soft keyboard) is used to receive one or more text entry inputs corresponding to a request to enter search text for performing a search of the transcript that comprises searching for text and/or metadata (e.g., chapter title, speaker's name, and/or the like) corresponding to the search text. In some embodiments, the one or more text entry inputs are received using a mechanism other than the second user interface element, such as a hardware keyboard and/or dictation. In some embodiments, the hardware keyboard is included in the one or more input devices in communication with the electronic device. In some embodiments, the computer system detects dictation by detecting speech via a microphone included in the one or more input devices. In some embodiments, the electronic device displays, via the display generation component, an option that, when selected causes the electronic device to navigate through each of the results of the search (e.g., display the respective portion of the transcript corresponding to each search result). Providing a user interface element associated with a search operation provides a quick way of searching the transcript without requiring the user to provide further inputs to scroll and traverse through the content item to get to the desired part of the content item, thereby reducing the number of inputs and providing more efficient interactions between the user and the electronic device.

In some embodiments, the tap input is received while playing the content item (e.g., as described above), and while displaying the second user interface element associated with the search operation (e.g., as described above), the electronic device displays, via the one or more input devices, a first input for the search operation, such as shown in FIG. 6P with text input 618nn and user interface element 618b. In some embodiments, the first input for the search operation includes one or more characteristics of the one or more text entry inputs described above. In some embodiments, the first input for the search operation corresponds to selection of an option to conduct a search operation, such as described above.

In some embodiments, in response to receiving the first input, the electronic device displays a first search result for the first input while continuing to play the content item, such as shown by indication of search result 622oo and the playing of the content item in FIG. 6Q. For example, displaying the first search result optionally does not cause the electronic device to stop playing the content item. In some embodiments, the electronic device continues to play the content item while receiving and/or performing the search operation described above. In some embodiments, the electronic device continues to play the content item while the electronic device navigates through each of the search results as described above. In some embodiments, in response to receiving the first input, the electronic device displays the first search result and stops or pauses playing the content item. In some embodiments, the electronic device temporarily stops or pauses paying the content item while the electronic device is performing the search operation (e.g., receiving selection of the first user interface element, displaying the second user interface element, receiving the first input, displaying the first search result, and/or any of the search operations described above). In some embodiments, the electronic device resumes playing the content item in response to an end of the search operation (e.g., receiving selection of an option to end the search operation, receiving selection of an option to cease displaying the first user interface element, the second user interface element, and/or the first search result described above). In some embodiments, the electronic device displays more than one search result. For example, the electronic device optionally displays the first search result and a second search result that, when selected optionally causes the electronic device to initiate playback of the content item at a position corresponding to the second search result (e.g., the portion of the transcript that includes the second search result). Displaying search results while continuing to play the content item avoids interrupting playback of the content item when continued playback of the content item is desired while performing the search operation, thereby reducing errors in the interaction between the user and the electronic device and reducing inputs needed to correct such errors.

In some embodiments, displaying the first search result includes displaying the first search result for the first input, such as shown by indication of the search result 622oo in FIG. 6Q, and changing the current playback position of the content item in accordance with playing the content item without skipping playback of the content item, such as shown by content player user interface element 620c in FIG. 6R. For example, displaying the first search result for the first input optionally includes displaying a respective portion of the transcript that does not correspond to the current playback position of the content item. In some embodiments, despite the electronic device displaying the respective portion of the transcript including the first search result that does not correspond to the current playback position of the content item, the electronic device continues playback of the content item (e.g., changes the current playback position of the content item in accordance with playing the content item without skipping playback of the content item). In some embodiments, alternatively, the electronic device displays the respective portion of the transcript including the first search result and changes the current playback position of the content item to a respective position of the content item corresponding to the portion of the transcript that includes the first search result. It is understood that although the embodiments described herein are directed to a first search result, such functions and/or characteristics, optionally apply to other search results. Displaying search results and changing the current playback position of the content item in accordance with playing the content item without skipping playback of the content item avoids interrupting playback of the content item when continued playback of the content item is desired while viewing results of the search operation, thereby reducing errors in the interaction between the user and the electronic device and reducing inputs needed to correct such errors.

In some embodiments, the content user interface includes a first user interface element, such as user interface element 668a in FIG. 6W. In some embodiments, the first user interface element is an additional options interface element that, when selected, causes the electronic device to display full menu interface element. In some embodiments, the full menu interface element includes one or more options that, when selected, cause the electronic device to perform one or more actions associated with the content item as described above. For example, a view transcript option that, when selected, causes the electronic device to display an entirety of the transcript of the content item as described herein. In some embodiments, the full menu interface element includes the one or more selectable options described above (e.g., play option, share option, copy option, and/or reporting option). In some embodiments, the full menu interface element includes one or more additional options, such as a search option that, when selected, causes the electronic device to perform a search operation as described above.

In some embodiments, while displaying the content user interface including the first user interface element, the electronic device receives, via the one or more input devices, a sequence of inputs corresponding to a request to view an entirety of the transcript of the content item, the sequence of inputs including selection of the first user interface element, such as option 668b in FIG. 6W. In some embodiments, the sequence of inputs corresponding to the request to view an entirety of the transcript of the content item includes any number of user inputs described above. For example, the sequence of inputs optionally include a tap input directed to the view transcript option described herein that, when selected, causes the electronic device to display the entirety of the transcript of the content item.

In some embodiments, in response to receiving the sequence of inputs, the electronic device displays, via the display generation component, a second content user interface including the first portion, the second portion, and the third portion of the transcript, such as user interface 672a in FIG. 6X. In some embodiments, the second content user interface is different from the content user interface described above. In some embodiments, the second content user interface and the content user interface are user interfaces of a same application (e.g., a podcast application or other media content application described above). In some embodiments, the second content user interface displays the transcript including the first portion, the second portion, and the third portion in a manner, layout, or style that is different from displaying the transcript via the content user interface. For example, the manner in which the electronic device displays the transcript by the second content user interface is optionally for the purpose of reading and interacting with the entirety of the transcript of the content rather than consuming the transcript in part and in synchrony with the content item being played. In another example, the second content user interface optionally displays the transcript in a manner that provides the user increased readability, better referencing (e.g., bookmarking), and/or the ability to annotate the transcript. Displaying a second content user interface that includes the first portion, the second portion, and the third portion of the transcript in response to a sequence of inputs corresponding to a request to view the entirety of the transcript avoids additional interaction between the user and the electronic device associated with searching for the entire transcript when seamless transition between the content user interface that includes the first portion of the transcript and the second content user interface that includes the first portion, the second portion, and the third portion of the transcript is desired, thereby reducing errors in the interaction between the user and the electronic device and reducing inputs needed to correct such errors.

In some embodiments, while displaying the second content user interface including the first portion, the second portion, and the third portion of the transcript, receiving, via the one or more input devices, a second sequence of inputs corresponding to a request to play the content item, such as input 672 in FIG. 6Z. In some embodiments, the second content user interface includes a play option that, when selected, causes the electronic device to play the content item via a second user interface element as described herein. In some embodiments, the second sequence of inputs corresponding to the request to play the content item includes any number of user inputs described above. For example, the second sequence of inputs optionally include a tap input directed to the play option described herein that, when selected, causes the electronic device to play the content item via a second user interface element.

In some embodiments, in response to receiving the sequence of inputs, playing the content item via a second user interface element that, when selected, causes the electronic device to display the content user interface including the first portion, the second portion, or the third portion of the transcript (e.g., the electronic device does not concurrently display the first, second, and third portions of the transcript) while playing the content item, such as shown in displaying user interface 676a in response to user input 672 in FIGS. 6Z and 6AA. In some embodiments, the second user interface element is a content player user interface element. In some embodiments, in response to receiving the sequence of inputs, the electronic device displays the second content user interface including the second user interface element. For example, the second user interface element is optionally displayed concurrently with or overlaid the second content user interface. In another example, the second user interface element is optionally displayed as partially-expanded such that a top (or left, right, or other) portion of the second content user interface includes the first portion, the second portion, and the third portion of the transcript and a bottom portion (or portion not occupied by the first portion, the second portion, and the third portion of the transcript) of the second content user interface includes the second user interface element. For example, playing the content item via the second user interface element optionally includes displaying the second content user interface including the second user interface element while playing the content item. In some embodiments, the electronic device receives, via the one or more input devices, a tap input or other input that corresponds to selection of the second user interface element. In some embodiments, in response to receiving the tap (or other) input that corresponds to selection of the second user interface element, the electronic device displays, via the display generation component, the content user interface including the first portion, the second portion, or the third portion of the transcript while playing the content item. In some embodiments, the electronic device displays the transcript in synchrony with the content item being played as discussed above. Alternatively, and in some embodiments, in response to receiving the tap input that corresponds to selection of the second user interface element, the electronic device displays the content user interface or the second content user interface including the second user interface element as fully expanded while playing the content item via the second user interface element. For example, the electronic device optionally displays the respective content user interface including the fully expanded second user interface element and does not include the transcript. In some embodiments, the second content user interface has one or more of the characteristics of content user interface described above. Playing the content item via a second user interface element in response to a sequence of inputs corresponding to a request to play the content item avoids additional interaction between the user and the electronic device associated with navigating to a content player user interface for performing the action of playing the content item when immediate action to play the content item is desired, which additionally reduces power usage and improves battery life of the electronic device by enabling the user to use the electronic device more quickly and efficiently.

In some embodiments, while displaying the second content user interface including a fourth portion of the transcript (e.g., the fourth portion of the transcript that corresponds to the current playback position of the content item), receiving, via the one or more input devices, a tap input that corresponds to selection of the fourth portion of the transcript, such as shown in FIG. 6BB with the selection of portion 684a of the transcript. In some embodiments, the tap input that corresponds to selection of the fourth portion of the transcript is a touch and hold on a touch sensitive surface that lasts for longer than the threshold period of time as described above.

In some embodiments, in response to receiving the tap input, displaying, via the display generation component, a second user interface element, such as user interface element 686a in FIG. 6BB, including one or more selectable options, such as options 686b-686e in FIG. 6BB, that, when selected, cause the electronic device to perform one or more actions associated with the fourth portion of the transcript, such as the action illustrated in FIGS. 6BB to FIG. 6CC. In some embodiments, the second user interface element including one or more selectable options has one or more characteristics as the menu user interface element described above. In some embodiments, the one or more selectable options provided by the second user interface element includes the one or more selectable options described above (e.g., play option, share option, copy option, and/or reporting option). For example, the one or more selectable options include a play option that, when selected, causes the electronic device to play the content item at a position corresponding to the fourth portion of the transcript. Providing selectable options that, when selected, cause the electronic device to perform one or more actions associated with the fourth portion of the transcript provides a quick way of performing the one or more actions, without requiring the user to provide further inputs to navigate away from the second content user interface to perform the one or more actions, thereby reducing the number of inputs and providing more efficient interactions between the user and the electronic device.

In some embodiments, a fourth portion of the transcript includes an indication of the current playback position of the content item, such as, for example, an indication that includes one or more same characteristics as the portion 680c of the transcript in FIG. 6AA. For example, the indication of the current playback position of the content item optionally includes text, images, book marking user interface elements identifying the current playback position of the content item. In some embodiments, the fourth portion that corresponds to the current playback position of the content item is displayed as visually emphasized (e.g., with a visual characteristic having a first value, a second value, or other value as described above) relative to other portions of the transcript (e.g., portions of the transcript other than the fourth portion). In some embodiments, the electronic device receives a user input (e.g., as described above) directed to the indication, and in response to receiving the user input directed to the indication, the electronic device plays the content item from the current playback position. In some embodiments, in accordance with a determination that a fifth portion of the transcript corresponds to the current playback position of the content item, the electronic device displays the fifth portion of the transcript including the indication of the current playback position of the content item; and foregoes displaying the fourth portion of the transcript including the indication of the current playback position of the content item. In some embodiments, other portions of the transcript that do not correspond to the current playback position of the content item do not include the indication of the current playback position of the content item. Providing an indication of the current playback position of the content item provides a quick way of indicating to the user the current playback position of the content item, without requiring the user to provide further inputs to navigate away from the second content user interface to identify the current playback position of the content item, thereby reducing the number of inputs and providing more efficient interactions between the user and the electronic device.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., a as described with respect to FIGS. 1A-1B, 3, 5A-5J) or application specific chips. Further, the operations described above with reference to FIG. 7 are, optionally, implemented by components depicted in FIGS. 1A-1B. For example, displaying operations 702a and/or 702b are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is presenting content items. The present disclosure contemplates that in some instances, the data utilized may include personal information data that uniquely identifies or can be used to contact or locate a specific person. Such personal information data can include demographic data, content consumption activity, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, content consumption activity can be used to suggest content to a user. Accordingly, use of such personal information data enables users to use electronic devices in coordinated manners. Further, other uses for personal information data that benefit the user are also contemplated by the present disclosure. For instance, content consumption data may be used to present content items while the electronic device is interacting with a content application.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location services, the present technology can be configured to allow users to select to “opt in” or “opt out” of participation in the collection of personal information data during registration for services or anytime thereafter. In another example, users can select not to enable content consumption activity tracking. In addition to providing “opt in” and “opt out” options, the present disclosure contemplates providing notifications relating to the access or use of personal information. For instance, a user may be notified upon initiating content playback that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content playback can proceed in accordance with the embodiments of the disclosure without tracking the content consumption activity of the user.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method comprising:
at an electronic device in communication with one or more input devices and a display generation component:
while playing a content item, displaying, via the display generation component, a content user interface including a first portion of a transcript of the content item;
while playing the content item and displaying the content user interface including the first portion of the transcript of the content item, receiving, via the one or more input devices, a scrolling input;
and in response to receiving the scrolling input:
scrolling the transcript in accordance with the scrolling input, including:
in accordance with a determination that a currently displayed portion of the transcript includes a second portion of the transcript that corresponds to a current playback position of the content item, scrolling the second portion of the transcript based on a first deceleration profile that includes decelerating by a first amount while displaying the second portion of the transcript that corresponds to the current playback position of the content item; and
in accordance with a determination that the currently displayed portion of the transcript is a third portion of the transcript, different from the second portion of the transcript, that does not correspond to the current playback position of the content item, scrolling the third portion of the transcript in a manner that is not based on the first deceleration profile that does not include decelerating by the first amount while displaying the third portion of the transcript.

2. The method of claim 1, further comprising:
while scrolling the transcript in accordance with the scrolling input, and before detecting an end of the scrolling input:
in accordance with a determination that the currently displayed portion of the transcript is a fourth portion of the transcript that corresponds to the current playback position of the content item, scrolling the fourth portion of the transcript in a manner based on movement of the scrolling input that is not based on the first deceleration profile that does not include decelerating by the first amount while displaying the fourth portion of the transcript that corresponds to the current playback position of the content item; and
in accordance with a determination that the currently displayed portion of the transcript is a fifth portion of the transcript, different from the fourth portion of the transcript, that does not correspond to the current playback position of the content item, scrolling the fifth portion of the transcript in the manner based on the movement of the scrolling input that is not based on the first deceleration profile that does not include decelerating by the first amount while displaying the fifth portion of the transcript.

3. The method of claim 1, wherein scrolling the transcript in accordance with the scrolling input includes:
in accordance with a determination that the scrolling input will cause the currently displayed portion of the transcript to include the second portion of the transcript during the scrolling in response to the scrolling input, forgoing display of one or more portions of the transcript before displaying the second portion of the transcript during the scrolling in response to the scrolling input; and
in accordance with a determination that the scrolling input will not cause the currently displayed portion of the transcript to include the second portion of the transcript during the scrolling in response to the scrolling input, displaying the one or more portions of the transcript during the scrolling in response to the scrolling input.

4. The method of claim 1, wherein:
while playing the content item and while not scrolling the transcript in response to receiving the scrolling input and while displaying the content user interface including the first portion of the transcript of the content item, the electronic device displays, via the display generation component, the first portion of the transcript with text having a first size; and
while scrolling the transcript in accordance with the scrolling input and displaying a respective portion of the transcript, the electronic device displays, via the display generation component, the respective portion of the transcript with text having a second size, less than the first size.

5. The method of claim 1, wherein while displaying the first portion of the transcript:
in accordance with a determination that the first portion of the transcript includes transcribable content or audio, the electronic device displays, via the display generation component, a transcription of the first portion of the transcript; and
in accordance with a determination that the first portion of the transcript does not include transcribable content or audio, the electronic device forgoes displaying, via the display generation component, the transcription of the first portion of the transcript.

6. The method of claim 1, wherein displaying the content user interface including the first portion of the transcript of the content item includes displaying a visual indication of a source of the transcript.

7. The method of claim 1, wherein displaying the first portion of the transcript includes:
displaying the first portion of the transcript with a visual characteristic having a first value and in accordance with a determination that the first portion of the transcript is associated with a name of a speaker, the electronic device displays, via the display generation component, a representation of the name of the speaker with a visual characteristic having a second value, different from the first value; and
in accordance with a determination that the first portion of the transcript is not associated with a the name of a speaker, the electronic device foregoes displaying, via the display generation component, the representation of the name of the speaker.

8. The method of claim 1, further comprising:
while scrolling the transcript in accordance with the scrolling input, displaying, via the display generation component, the first portion of the transcript with a visual characteristic having a first value;
while scrolling the transcript in accordance with the scrolling input and displaying a respective portion of the transcript with the visual characteristic having the first value, receiving, via the one or more input devices, a tap input directed to a fourth portion of the transcript; and
in response to receiving the tap input, displaying, via the display generation component, the fourth portion of the transcript with the visual characteristic having a second value, different from the first value.

9. The method of claim 1, further comprising:
while displaying the content user interface including the first portion of the transcript of the content item, receiving, via the one or more input devices, a tap input that corresponds to selection of the first portion of the transcript; and
in response to receiving the tap input, in accordance with the tap input satisfying one or more criteria, displaying, via the display generation component, one or more selectable options that, when selected, cause the electronic device to perform one or more actions associated with the first portion of the transcript.

10. The method of claim 1, wherein the content user interface includes an indication of metadata associated with a first part of the content item.

11. The method of claim 10, further comprising:
while displaying the content user interface including the indication of the first part of the content item, receiving, via the one or more input devices, a tap input that corresponds to selection of the indication of the first part of the content item; and
in response to receiving the tap input, displaying, via the display generation component, a user interface element that, when selected, causes the electronic device to navigate to a second part of the content item, different from the first part of the content item.

12. The method of claim 1, wherein the content user interface includes a first user interface element, the method further includes:
while displaying the content user interface including the first user interface element, receiving, via the one or more input devices, a tap input that corresponds to selection of the first user interface element; and
in response to receiving the tap input, displaying, via the display generation component, a second user interface element associated with a search operation associated with searching the transcript.

13. The method of claim 12, wherein the tap input is received while playing the content item, the method further comprising:
while displaying the second user interface element associated with the search operation, receiving, via the one or more input devices, a first input for the search operation; and
in response to receiving the first input, display a first search result for the first input while continuing to play the content item.

14. The method of claim 13, wherein displaying the first search result includes:
displaying the first search result for the first input; and
changing the current playback position of the content item in accordance with playing the content item without skipping playback of the content item.

15. The method of claim 1, wherein the content user interface includes a first user interface element, the method further includes:
while displaying the content user interface including the first user interface element, receiving, via the one or more input devices, a sequence of inputs corresponding to a request to view an entirety of the transcript of the content item, the sequence of inputs including selection of the first user interface element; and
in response to receiving the sequence of inputs, displaying, via the display generation component, a second content user interface including the first portion, the second portion, and the third portion of the transcript.

16. The method of claim 15, further comprising:
while displaying the second content user interface including the first portion, the second portion, and the third portion of the transcript, receiving, via the one or more input devices, a second sequence of inputs corresponding to a request to play the content item; and
in response to receiving the sequence of inputs, playing the content item via a second user interface element that, when selected, causes the electronic device to display the content user interface including the first portion, the second portion, or the third portion of the transcript while playing the content item.

17. The method of claim 15, further comprising:
while displaying the second content user interface including a fourth portion of the transcript, receiving, via the one or more input devices, a tap input that corresponds to selection of the fourth portion of the transcript; and
in response to receiving the tap input, displaying, via the display generation component, a second user interface element including one or more selectable options that, when selected, cause the electronic device to perform one or more actions associated with the fourth portion of the transcript.

18. The method of claim 15, wherein a fourth portion of the transcript includes an indication of the current playback position of the content item.

19. An electronic device comprising:
one or more processors;
memory; and
one or more programs, wherein the one or more programs are stored in the memory and configured to be executed by the one or more processors, the one or more programs including instructions for:
while playing a content item, displaying, via a display generation component, a content user interface including a first portion of a transcript of the content item;
while playing the content item and displaying the content user interface including the first portion of the transcript of the content item, receiving, via one or more input devices, a scrolling input;
and in response to receiving the scrolling input:
scrolling the transcript in accordance with the scrolling input, including:
in accordance with a determination that a currently displayed portion of the transcript includes a second portion of the transcript that corresponds to a current playback position of the content item, scrolling the second portion of the transcript based on a first deceleration profile that includes decelerating by a first amount while displaying the second portion of the transcript that corresponds to the current playback position of the content item; and
in accordance with a determination that the currently displayed portion of the transcript is a third portion of the transcript, different from the second portion of the transcript, that does not correspond to the current playback position of the content item, scrolling the third portion of the transcript in a manner that is not based on the first deceleration profile that does not include decelerating by the first amount while displaying the third portion of the transcript.

20. A non-transitory computer readable storage medium storing one or more programs, the one or more programs comprising instructions, which when executed by one or more processors of an electronic device, cause the electronic device to perform a method comprising:
while playing a content item, displaying, via a display generation component, a content user interface including a first portion of a transcript of the content item;
while playing the content item and displaying the content user interface including the first portion of the transcript of the content item, receiving, via one or more input devices, a scrolling input;
and in response to receiving the scrolling input:
scrolling the transcript in accordance with the scrolling input, including:
in accordance with a determination that a currently displayed portion of the transcript includes a second portion of the transcript that corresponds to a current playback position of the content item, scrolling the second portion of the transcript based on a first deceleration profile that includes decelerating by a first amount while displaying the second portion of the transcript that corresponds to the current playback position of the content item; and
in accordance with a determination that the currently displayed portion of the transcript is a third portion of the transcript, different from the second portion of the transcript, that does not correspond to the current playback position of the content item, scrolling the third portion of the transcript in a manner that is not based on the first deceleration profile that does not include decelerating by the first amount while displaying the third portion of the transcript.
